(19) United States
(12) Patent Application Publication
(10) Pub. No.: US 2023/0097142 A1
(43) Pub. Date: Mar. 30, 2023

(54) METHODS, APPARATUS, AND SYSTEMS FOR RELIABLE CHANNEL STATE INFORMATION REPORTING

(71) Applicant: IDAC Holdings, Inc., Wilmington (DE)

(72) Inventors: Faris Alfarhan, MONTRÉAL (CA); Paul Marinier, Brossard (CA); J. Patrick Tooher, Montreal (CA); Ghyslain Pelletier, Montréal (CA); Aata El Hamss, Laval (CA); Moon IL Lee, Melville, NY (US); Ananth Kini, Conshohocken, PA (US)

(21) Appl. No.: 17/798,785

(22) PCT Filed: Feb. 10, 2021
(86) PCT No.: PCT/US2021/017416

§ 371 Date: Aug. 10, 2022

Related U.S. Application Data
(60) Provisional application No. 62/975,509, filed on Feb. 12, 2020.
(60) Provisional application No. 63/061,387, filed on Aug. 5, 2020.
(60) Provisional application No. 63/091,546, filed on Oct. 14, 2020.

(51) Int. Cl. H04W 72/1268; H04W 72/23; H04B 17/318; H04L 5/00

(52) U.S. Cl. CPC H04W 72/1268; H04W 72/23; H04B 17/318; H04L 5/0051

(57) ABSTRACT

Methods, apparatus, and systems are disclosed. In one embodiment, a method of reporting Channel State Information (CSI) by a wireless transmit/receive unit (WTRU) includes receiving configuration information indicating a plurality of CSI reporting configurations and information indicating multiple downlink (DL) semi-persistent scheduling (SPS) resource configurations, wherein each indicated DL SPS resource configuration is associated with a CSI reporting configuration; and receiving an indicator indicating which one or more of the multiple DL SPS resource configurations are active. The method further includes determining one or more measurement time/frequency resources based on a respective CSI reporting configuration or respective CSI reporting configurations associated with the one or more active DL SPS resource configurations; performing one or more measurements on the determined measurement time/frequency resources; and reporting CSI, wherein the CSI is based on the one or more measurements.

### CROSS-REFERENCE TO RELATED APPLICATIONS

The application claims the benefit of priority to U.S. Provisional Patent Application Ser. No. 63/091,546, filed Oct. 14, 2020, U.S. Provisional Patent Application Ser. No. 63/061,387, filed Aug. 5, 2020, and U.S. Provisional Patent Application Ser. No. 62/975,509, filed Feb. 12, 2020, the contents of each of which is incorporated herein by reference.

### FIELD

Embodiments disclosed herein generally relate to wireless communications and, for example to methods, apparatus, and systems for channel state information reporting (e.g., reliably).

### RELATED ART

Certain reporting from a wireless mobile device may include channel state information.

### SUMMARY

Methods and apparatus for operation by a wireless transmit/receive unit (WTRU) in a network are provided. In one embodiment, a method may include receiving configuration information indicating a plurality of CSI reporting configurations and information indicating multiple downlink (DL) semi-persistent scheduling (SPS) resource configurations. Each indicated DL SPS resource configuration may be associated with a CSI reporting configuration. The method may further include receiving an indicator indicating which one or more of the multiple DL SPS resource configurations are active and determining one or more measurement time/frequency resources based on a respective CSI reporting configuration or respective CSI reporting configurations associated with the one or more active DL SPS resource configurations. The method may also include performing one or more measurements on the determined measurement time/frequency resources and reporting CSI. The CSI may be based on the one or more measurements.

### BRIEF DESCRIPTION OF THE DRAWINGS

A more detailed understanding may be had from the detailed description below, given by way of example in conjunction with drawings appended hereto. Figures in the description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating a representative Configured Grant (CG) selection procedure;

FIG. 3 is a diagram illustrating another representative CG selection procedure;

FIG. 4 is a diagram illustrating a WTRU configured with multiple (e.g., three) CSI reporting patterns and an example of switching between the configured reporting patterns;

FIG. 5 is a diagram illustrating an example of WTRU selective CSI reporting;

FIG. 6 is a diagram illustrating another example of WTRU selective CSI reporting;

FIG. 7 is a diagram illustrating enhanced CSI reporting using multiple CSI RS resource configurations;

FIG. 8 is a flowchart illustrating a representative method of reporting Channel State Information (CSI);

FIG. 9 is a flowchart illustrating another representative method of reporting Channel State Information (CSI);

FIG. 10 is a flowchart illustrating a representative method of UCI and/or CSI reporting;

FIG. 11 is a flowchart illustrating another representative method of UCI and/or CSI reporting;

FIG. 12 is a flowchart illustrating a further representative method of reporting CSI;

FIG. 13 is a flowchart illustrating a still further representative method of reporting CSI;

FIG. 14 is a flowchart illustrating an additional representative method of reporting CSI; and

FIG. 15 is a flowchart illustrating a representative method of reporting;

FIG. 16 is a flowchart illustrating a yet further representative method of reporting CSI;

FIG. 17 is a flowchart illustrating another representative method of reporting CSI;

FIG. 18 is a flowchart illustrating a representative method using configured grants;

FIG. 19 is a flowchart illustrating a further representative method of reporting CSI; and

FIG. 20 is a flowchart illustrating a still further representative method of reporting CSI.

### DETAILED DESCRIPTION

### Example Networks for Implementation of the Embodiments

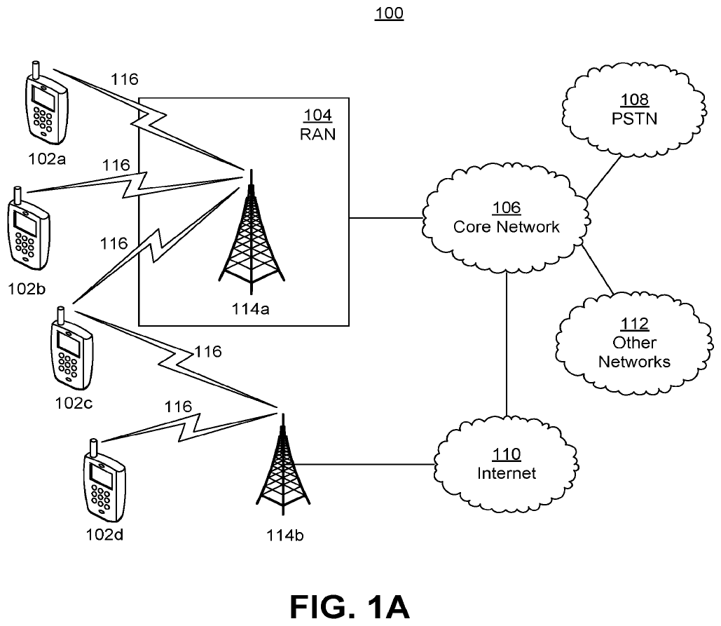

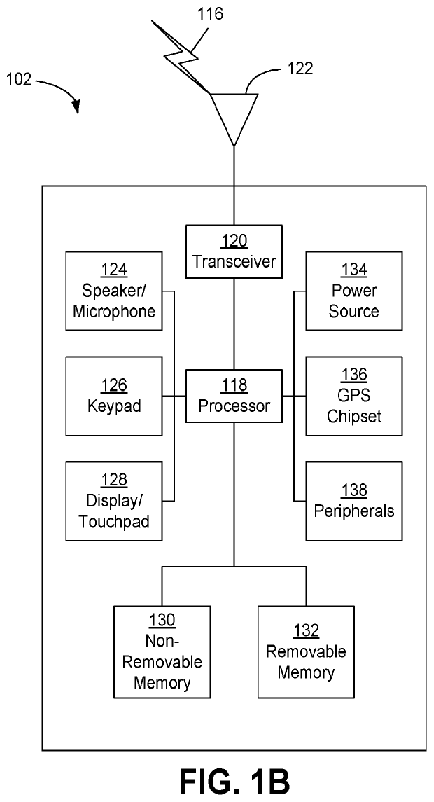

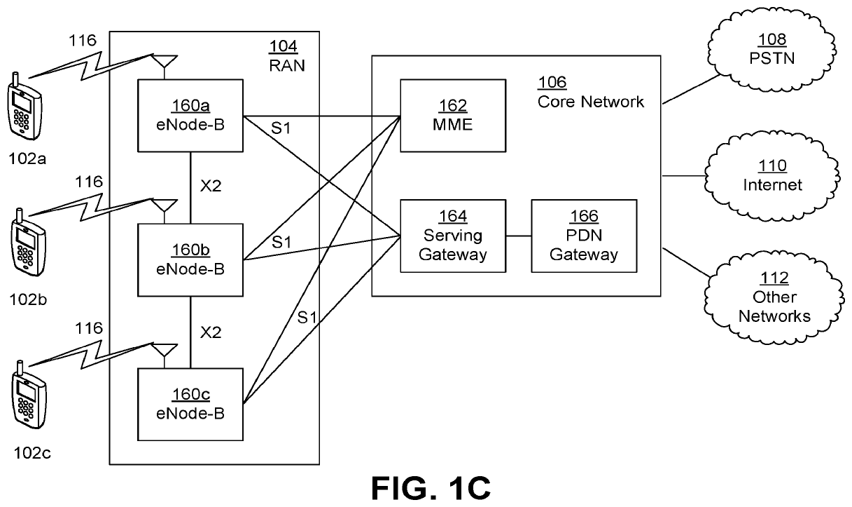

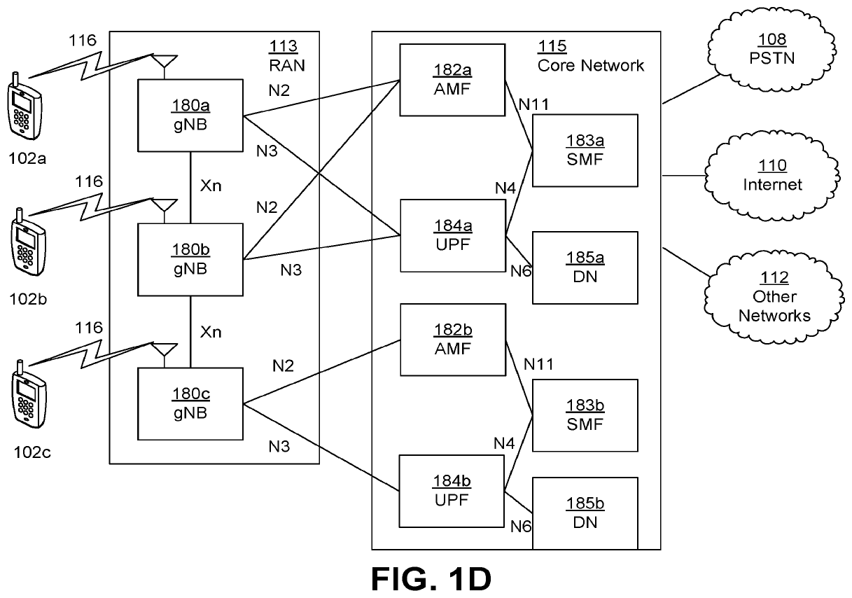

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (end), a Home Node B (HNB), a Home eNode B (HeNB), a gNB, a NR Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an end and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The processor 118 of the WTRU 102 may operatively communicate with various peripherals 138 including, for example, any of: the one or more accelerometers, the one or more gyroscopes, the USB port, other communication interfaces/ports, the display and/or other visual/audio indicators to implement representative embodiments disclosed herein.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode Bs 160a, 160b, 160c, though it will be appreciated that the RAN 104 may include any number of eNode Bs while remaining consistent with an embodiment. The eNode Bs 160a, 160b, 160c may each include one or more transceivers for communicating with the WTRUs 102a, 102b, 102c over the air interface 116. In one embodiment, the eNode Bs 160a, 160b, 160c may implement MIMO technology. Thus, the eNode B 160a, for example, may use multiple antennas to transmit wireless signals to, and/or receive wireless signals from, the WTRU 102a.

Each of the eNode Bs 160a, 160b, 160c may be associated with a particular cell (not shown) and may be configured to handle radio resource management decisions, handover decisions, scheduling of users in the UL and/or DL, and the like. As shown in FIG. 1C, the eNode Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode Bs 160a, 160b, 160c. For example, WTRUs 102a, 102b, 102c may implement DC principles to communicate with one or more gNBs 180a, 180b, 180c and one or more eNode Bs 160a, 160b, 160c substantially simultaneously. In the non-standalone configuration, eNode Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Protocol Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced mobile (e.g., massive mobile) broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Channel-dependent scheduling is commonly used in cellular systems. OFDMA may allow scheduling to be performed in both the frequency and time domains. Channel-dependent scheduling may provide a scheduler flexibility to select a suitable modulation and coding scheme (MCS), while exploiting the channel's time-frequency selectivity, for example, to allocate available radio resources in an optimal manner. Users can periodically report the Channel Quality Indicator (CQI) through the uplink control channel on the Physical Uplink Control Channel (PUCCH), and/or per the request of the network (e.g., a network entity or a gNB 180) on an Uplink (UL) grant (e.g., a Physical Uplink Shared Channel (PUSCH) grant). The reported CQI may be used by the scheduler when allocating resource blocks and selecting suitable MCSs.

New Radio (NR) can support serving UEs with one or more services of varying latency and/or reliability requirements, including Ultra-Reliable and Low Latency Communications (URLLC) and/or enhanced Mobile Broadband (eMBB) services. To better support operation with different types of service, such as URLLC and eMBB, certain transmissions can be received with a higher level of latency and/or reliability. The reliability, accuracy, and/or timeliness of WTRU feedback reports, including CQI and/or Hybrid Automatic Repeat Request-Acknowledgement (HARQ-ACK), may be set and/or critical to meet URLLC service requirements.

In NR, a WTRU (e.g., each WTRU) can be configured with Channel State Information-Reference Signal (CSI-RS) resources on which the WTRU may make some Layer 1 (L1) measurements, including CQI and/or others. Although the CSI-RS resources may be configured per device (e.g., per UE), the network (e.g., a network entity) can use the same resource for multiple UEs. UEs may perform higher layer measurements, such as Reference Signal Received Power (RSRQ) and Reference Signal Received Power (RSRP), based on measuring Synchronization Signal Blocks (SSBs) and/or CSI-RS from one or more cells.

Depending on the configuration, CSI-RS can cover the full bandwidth of a bandwidth part (BWP) and/or just a fraction of the BWP. Within the CSI-RS bandwidth, CSI-RS can be configured in each Physical Resource Block (PRB), a portion of the PRBs and/or every other PRB. In the time domain, CSI-RS resources can be configured either periodic, semi-persistent, and/or aperiodic. Semi-persistent CSI-RS may be similar to periodic CSI-RS, except that the resources can be activated or deactivated by one or more MAC Control Elements (MAC CEs). The WTRU may report related measurements when (e.g., only when) the resource is activated. For aperiodic CSI-RS, the WTRU may be triggered to report measured CSI-RS on the PUSCH by request in Downlink Control Information (DCI). Periodic reports may be carried on or over the PUCCH, and semi-persistent reports can be carried on or over the PUCCH and/or the PUSCH.

Based on the configured CSI-RS resource set or sets, the reporting quantities and reporting frequency, the UEs can provide L1 measurements including CQI, a rank indicator (RI), a RSRP and/or a precoding matrix indicator (PMI). A CSI-RS resource set may include a set of SSBs to measure. The scheduler may leverage the reported CQI to select an appropriate MCS. This process may be referred to herein as link adaptation.

### Representative Procedures for 3GPP NR

NR may support flexible transmission duration within a slot and/or “configured grant” (GC) type-1 for uplink (UL) transmissions, where the network may semi-statically configure an UL grant and the WTRU may autonomously use the semi-statically configured UL grant without a L1 indication/activation. CG type-2 may be similar to CG type-1 and may use/consider a L1 indication/activation. NR may support Downlink (DL) Semi-Persistent Scheduling (SPS) resources and/or DL CGs, on which the WTRU may receive DL data on active DL CGs with no scheduling used/necessary for a DL Transport Block (TB) (e.g., each DL TB).

NR may support UL and/or DL services of different QoS requirements within a single WTRU, including traffic of varying latency requirements and/or varying reliability requirements. NR may support time-sensitive communications and/or networking, including deterministic and non-deterministic Time-Sensitive Networking (TSN) traffic patterns and/or flows, which can be prevalent in factory automation settings using licensed spectrum and/or unlicensed spectrum. A Time-Sensitive Communications (TSC) flow (e.g., each TSC flow) can be configured with a number of QoS parameters, including a periodicity, a burst arrival time, and/or a survival time. The survival time may set/convey the time that an application consuming a communication service may continue without an anticipated message. If a message is not successfully delivered, a message loss of the next message within the survival time can be tolerable. The survival time may relax the QoS requirement associated with the reliability. The scheduler may use this information for resource allocation, e.g., increasing MCS reliability when appropriate and/or needed and/or increasing spectral efficiency, for example by changing the MCS.

CSI may include any of the following: one or more channel quality indexes (CQIs), one or more rank indicators (RIs), one or more precoding matrix indexes (PM Is), one or more layer 1 (L1) (e.g., physical layer) channel measurements (e.g., a RSRP such as an L1-RSRP, or a Signal-to-Interference Ratio (SINR)), a CSI-RS resource indicator (CRI), a SS/Physical Broadcast Channel (PBCH) block resource indicator (SSBRI), a layer indicator (LI) and/or any other measurement quantity measured by the WTRU from the configured CSI-RS or SS/PBCH block.

UL control information (UCI) may include: the CSI, HARQ feedback for one or more HARQ processes, one or more Scheduling Requests (SRs), a Link Recovery Request (LRR), a CG-UCI and/or other control information bits that may be transmitted using/on the PUCCH and/or the PUSCH.

Channel conditions may generally refer to one or more or any conditions relating to the state of the radio/channel and may be determined by the WTRU from: a WTRU measurement (e.g., L1/SINR/RSRP, CQI/MCS, channel occupancy, Received Signal Strength Indicator (RSSI), power headroom, and/or exposure headroom), Layer 3 (L3)/mobility-based measurements (e.g., RSRP, RSRQ), an RLM state, and/or channel availability in unlicensed spectrum (e.g., whether the channel is occupied based on determination of an Listen Before Talk (LBT) procedure and/or whether the channel is deemed/determined to have experienced a consistent LBT failure).

In certain operations (e.g., normal operations), a scheduler may determine an MCS, for example by applying a bias to the MCS corresponding to a reported CQI (e.g., by the UE). The bias may be obtained by an adaptation operation (e.g., an outer-loop link adaptation procedure) that may target a certain HARQ Block Error Rate (BLER) level (e.g., maintain and/or attempt to maintain a target HARQ BLER level and/or meet at least a threshold HARQ BLER level). Without accurate and/or timely CQI reports, the scheduler may resort to assigning an overly conservative MCS to meet the reliability (e.g., required reliability) of the service. For example, without timely and/or reliable CQI reports, the scheduler may risk segmenting a latency critical packet into more than one TB and/or using many PRBs, which may not always be available, and thus affecting spectral efficiency.

In the context of URLLC, retransmissions and/or segmentation can be costly from a latency timeline perspective. An URLLC traffic pattern with a long periodicity and/or few transmissions per burst may lead to not enough samples to operate (e.g., appropriately operation) the adaptation operation (e.g., the outer-loop link adaptation procedure). The reliability, accuracy, and/or promptness of WTRU CQI reports may be useful. Overprovisioning CSI-RS and/or PUCCH resources to report CSI may provide timely link adaption and may come with the cost of overhead in the UL and/or DL.

In certain representative embodiments, methods, operations, and/or procedures may be implemented for the WTRU to implicitly report aperiodic CSI upon, in response to and/or after satisfying a triggering condition.

In certain representative embodiments, methods, operations, and/or procedures may be implemented for PUCCH resource activation upon, in response to, and/or after reporting a-periodic CSI.

In certain representative embodiments, methods, operations, and/or procedures may be implemented for UL resource/grant selection based on: any of: (1) measured channel conditions, (2) CQI and/or TB size (TBS).

In certain representative embodiments, methods, operations, and/or procedures may be implemented for configuration of multiple CSI reporting patterns. For example, the WTRU may switch between CSI reporting patterns based on satisfying triggers/conditions (e.g., scheduling priority and/or timer expiry, among others).

In certain representative embodiments, methods, operations, and/or procedures may be implemented for WTRU selective reporting of UCI/CSI, for example to reduce UCI overhead (e.g., when CSI reporting occasions may be or are overprovisioned).

In certain representative embodiments, methods, operations, and/or procedures may be implemented for CSI reporting (e.g., customized CSI reporting) to suite specific resource allocation and/or indicated resources.

In certain representative embodiments, methods, operations, and/or procedures may be implemented for CSI reporting (or CSI reporting delay/nonreporting) based on activation (or deactivation) of triggers using MAC CE or conditional semi-persistent reporting.

In certain representative embodiments, methods, operations, and/or procedures may be implemented for resource allocation (e.g., multiplexing CSI or HARQ-ACK in same resource or using different resources based on a PUCCH resource indicator (PRI).

In certain representative embodiments, methods, operations, and/or procedures may be implemented for conditional triggering of pre-configured aperiodic CSI reporting (e.g., on the PUCCH).

In certain representative embodiments, methods, operations, and/or procedures may be implemented for enhanced CSI measurements based on statistical measurements and/or demodulation of PDSCH.

In certain representative embodiments, methods, operations, and/or procedures may be implemented to perform enhanced CSI measurements including, for example, triggers to begin taking such measurements.

In certain representative embodiments, methods, operations, and/or procedures may be implemented including rules to determine what enhanced CSI measurement to report (e.g., from a set of possible CQI values).

In certain representative embodiments, methods, operations, and/or procedures may be implemented to report enhanced CSI measurements (e.g., multiplexed with CSI and/or with HARQ-ACK).

In certain representative embodiments, methods, operations, and/or procedures may be implemented including rules to determine priority of enhanced CSI measurement reports.

Representative Procedures for Enhanced CSI Reporting (e.g., Aperiodic, Periodic and/or Semi-Persistent)

### Representative Procedures for Enhanced Triggered CSI Reporting

The term “aperiodic CSI” may generally refer to any CSI triggered based on any of the embodiments disclosed herein, and is not limited to the aperiodic CSI triggering mechanism defined in existing systems. For example, the term “aperiodic CSI” may refer to a CSI report from a conditional semi-persistent or periodic CSI configuration described herein.

A WTRU may be triggered to report CSI in an aperiodic manner. The WTRU may receive explicit indication from the gNB 180 triggering the aperiodic CSI report. In certain examples, the WTRU may determine to report CSI in an implicit manner. The WTRU may use at least one of the following as a trigger to report aperiodic CSI:
(1) a reception of DCI for DL scheduling and/or UL scheduling,
   possibly for (e.g., only for) certain values of DCI fields or for certain PDCCH properties; (for example, if or on condition that the WTRU is scheduled with a DL or UL transmission with a specific priority (e.g., high and/or highest priority), or if the WTRU receives a DCI indicating a specific priority for HARQ-ACK (e.g., highest priority), the WTRU may be triggered to report aperiodic CSI or CSI for a specific CSI report configuration. In another example, if the WTRU receives a DCI containing or including a DL assignment with a certain value of a PUCCH resource indicator, and/or for a certain value of a new field indicating whether CSI is triggered and/or indicating one of a set of CSI trigger and/or report configurations configured by higher layers. The applicable priority may be configured as part of the CSI report configuration. In another example, a WTRU may be triggered to report aperiodic CSI when or on condition that a DL transmission or an UL transmission is expected on a different beam than a previous transmission. The beam may be determined in terms of a quasi-co-location to an RS (e.g., a CSI-RS and/or an SRS));
(2) a reception of DCI of UE-group common signaling
   (for example., used for WTRU group common signaling), for example per a DCI format (e.g., a newly defined DCI format). As another example, the WTRU may receive, from higher layer signaling, a configuration for reception of such UE-group common signaling (e.g., one or more RNTI, search spaces, one or more DCI formats, etc.), an indication of an index for a location of bits in a DCI format that indicate at least one CSI report triggered. For example, the bits may indicate at least one of:
      (i) an aperiodic CSI trigger state;
      (ii) a bitmap (e.g., each position in the bitmap may correspond to a CSI report configuration, via a mapping received from higher layer signaling. For example, the WTRU may transmit a CSI report for each CSI report configuration indicated by the bitmap);
      (iii) an indication of a CSI report configuration (for example including a PUCCH resource);
      (iv) an indication of a PUCCH resource and/or a slot (e.g., as a delay from reception of DCI) in which to transmit the CSI report;
      (v) the mapping between an indication received in the DCI and the CSI report configuration identity, (e.g., the PUCCH resource and/or slot or delay may be received from higher layer signaling));
(3) an SPS activation,
   (for example, if or on condition that the WTRU receives an SPS activation tied to a specific priority, the WTRU may be triggered to report aperiodic CSI. The activation may be via semi-static signaling (e.g., RRC and/or higher layer signaling) and/or may be via dynamic signaling (e.g., via DCI and/or lower layer signaling));
(4) reception of a DL transmission (e.g., a high priority DL transmission, for example a Physical Downlink Shared Channel (PDSCH) transmission) and/or transmission of an UL transmission (e.g., a high priority UL transmission, for example a PUSCH transmission and/or a PUCCH transmission), (for example, upon, in response to, and/or after transmitting and/or receiving high priority data (e.g., on a CG resource), the WTRU may be triggered to report aperiodic CSI);
(5) reception of a MAC CE,
   (for example, upon, in response to, and/or after receiving a MAC CE associated with a high priority and/or a highest priority, the WTRU may be triggered to report aperiodic CSI (e.g., may trigger the generation and/or the transmission of a CSI report));
(6) transmission and/or triggering of a SR,
   (for example, upon, in response to, and/or after transmitting and/or triggering the SR for one or more high priority transmissions, the WTRU may be triggered to report aperiodic CSI (e.g., may trigger the generation and/or the transmission of a CSI report));
(7) transmission and/or triggering of a Buffer Status Report (BSR),
   (for example, upon, in response to, and/or after transmitting and/or triggering the BSR indicating priority data (e.g., high priority data), the WTRU may be triggered to report aperiodic CSI (e.g., may trigger the generation and/or the transmission of a CSI report));
(8) data arrival for certain services (e.g., one or more types of service), certain data radio bearers (DRBs), certain Logical Channel Groups (LCGs), certain Logical Channels (LCHs), and/or certain priority levels,
   (for example, when a WTRU receives data for a specific LCH, the WTRU may be triggered to transmit an aperiodic CSI report, (e.g., may trigger the generation and/or the transmission of a CSI report));
(9) a change in CSI measurements and/or measured channel conditions,
   (for example, the WTRU may be triggered to report aperiodic CSI reports, if one or more of the report types has changed since a previous (aperiodic/periodic/semi-persistent) CSI report. Whether a report has changed since a previous report may be determined in terms of the change being greater than (e.g., exceeding) a threshold that may be fixed or configurable. For example, if the CQI has changed beyond a threshold since or after a previous report (e.g., a last CSI report), the WTRU may be triggered to report a new aperiodic CSI. The new aperiodic CSI report may include relevant (e.g., all relevant) and/or configurable CSI report types or may only include the CSI report types that have changed since the last CSI report. The new aperiodic CSI report may include one or more CSI values, one or more indexed values representing CSI values, one or more offset values relative to the previously reported CSI values/indexed values and/or one or more indexed values representing offset CSI values relative to the previously reported values. The offset and/or indexed values, for example, may improve granularity).
(10) based on HARQ-ACK report and/or HARQ-ACK codebook values,
   (for example, if a HARQ-ACK report/codebook has more NACKs than a threshold and/or a higher NACK percentage than a threshold, the WTRU may be triggered to report aperiodic CSI. For example, if a WTRU has a HARQ-ACK report for which there are x % Negative ACKs (NACKs) and x>threshold, then the WTRU may be triggered to report aperiodic CSI. In another example, a WTRU may be triggered to report aperiodic CSI, if the percentage and/or number of failed to decode Code Blocks/Code Block Groups is above (e.g., exceeds) one or more thresholds). In certain representative embodiments, the ACKs, NACKs, decoded Code Blocks/Code Block Groups, and/or failed to decode Code Blocks/Code Block Groups may be used to determine whether to trigger an aperiodic CSI report based on one or more predetermined, signaled and/or configured rules);
(11) based on a decoding performance,
   (for example, if the WTRU determines that an MCS used for the transmission was conservative or aggressive (e.g., too conservative, or too aggressive) based on an instantaneous Signal Interference to Noise Ratio (SINR) and/or an expected BLER, the WTRU may be triggered to report aperiodic CSI. The WTRU may determine that the MCS was conservative based on any of: (1) the SINR being greater than a threshold (e.g., a set and/or required threshold) plus an offset for the MCS, and/or (2) the expected BLER. The WTRU may determine that the MCS was aggressive based on any of: (1) the SINR being less than the threshold (e.g., the set/required threshold) plus the same or a different offset for the MCS, (2) the expected BLER and/or (3) a HARQ-ACK status);
(12) based on whether the scheduled transmission is a new transmission or a retransmission,
   (for example, a WTRU may be configured to trigger aperiodic CSI report, if the scheduling DCI has or includes a toggled New Data Indicator (NDI) or an untoggled NDI. In one example, a WTRU may be configured to report CSI upon, in response to and/or after receiving a new transmission (e.g., in accordance with the NDI) and if the HARQ-ACK status of the new transmission is a NACK); and/or
(13) based on a number of retransmissions that a TB was retransmitted,
   (for example, a WTRU may be configured to transmit an aperiodic CSI report, if the TB is being retransmitted for a threshold number K of times and/or attempted retransmissions without successful decoding. The threshold number K (e.g., in RRC signaling or DCI signaling may be pre-configured and/or dynamically indicated), among other.

In some representative embodiments, even though criterion for an aperiodic report trigger mechanism has been satisfied, the WTRU may not send the aperiodic CSI report (e.g., report aperiodic CSI). Whether or not a trigger mechanism is valid at any given moment may depend on at least one of:
(1) a time elapsed since the last and/or previous CSI report was transmitted, (for example, a WTRU may be configured with an amount of time (e.g., a minimum and/or a maximum amount of time) between two CSI reports. For example, if a WTRU is triggered to report aperiodic CSI in slot n and has recently transmitted a CSI report (e.g., an aperiodic CSI report, a periodic CSI report and/or a semi-persistent CSI report) in slot n−x, the WTRU may not report CSI report in slot n if x<M, where M may be predetermined, signaled and/or configurable);
(2) content of the CSI report has not changed or has not changed significantly since an immediately preceding or last CSI report (e.g., an aperiodic CSI report, a periodic CSI report and/or a semi-persistent CSI report),
   (for example, if the CQI has changed less than a threshold (e.g., which may be predetermined, signaled and/or configurable) since a preceding or the last CSI report, the WTRU may skip transmitting the triggered aperiodic CSI report. This may be used (e.g., may only be used) if an immediately preceding CSI report is still valid. Validity may be determined based on the time elapsed since the CSI report was transmitted. For example, an immediately preceding CSI report transmitted more than T slots prior to the triggered CSI report may not be valid), and/or
(3) the current state of UL and/or DL transmissions,
   (for example, a trigger and/or trigger mechanism may be valid, if (e.g., only if) the WTRU is actively receiving and/or transmitting priority data (e.g., high priority data, which may excess a threshold priority). Whether a WTRU is actively receiving and/or transmitting priority data may be determined by any of: (1) if there is an active CG resource for the high priority data; (2) if there is high priority data in the buffer of the UE, (e.g., as determined by a LCH, a Resource Block (RB) type and/or a service type); (3) if the WTRU has one or more active HARQ processes (for UL and/or DL) used for one or more priority transmissions (e.g., a high priority transmission) (e.g., a HARQ process for which the buffer has not been cleared); (4) if SPS is activated for the one or more priority transmissions (e.g., a high priority transmission), among others.

It is contemplated that the identification of priority data (e.g., high priority data) may be taken to mean the highest priority data and/or may be a configurable level or a pre-determined level of priority.

### Representative Conditions (e.g., Multiple Conditions) for Activated or Delayed/Deactivated Triggering

In certain representative embodiments, a WTRU may report CSI based on one or multiple conditions such as any of the conditions described herein. For example, a WTRU may first receive signaling activating or deactivating a trigger condition for at least one CSI report configuration. Such signaling may be via RRC signaling or in a MAC CE, DCI, a Master Information Block (MIB) and/or a System Information Block (SIB), among others. A MAC CE or other signaling may, for example, include a bitmap where each bit position may correspond to a CSI report configuration and the value of each bit may determine whether the trigger condition is activated or deactivated for the corresponding CSI report. The WTRU may transmit (e.g., only transmit) a CSI report for a CSI report configuration and/or aperiodic trigger state, if the trigger is activated and the trigger condition is met. For example, a WTRU may transmit (e.g., only transmit) a CSI report, if the WTRU receives a DCI from a DCI format from UE-group common signaling triggering such a transmission and if the trigger is activated, for example per a previous reception of such an indication (e.g., via a MAC CE or another signaling procedure). In another example, a WTRU may transmit (e.g., only transmit) a CSI report, if the WTRU receives a DCI with a specific RNTI and if the trigger is activated, for example, per a previous reception of such an indicator (e.g., via information and/or a bitmap in the MAC CE, among others).

Although procedures for activation/deactivation of CSI report triggers are disclosed, other type of triggers may also be activated deactivation in a similar manner. For example, activation/deactivation of triggering may be used with SRS transmissions. The procedures set forth herein may be interchangeably used with SRS transmission. In addition, the same or similar triggering conditions for a CSI report configuration may be applicable and/or used for triggering conditions for SRS configuration and/or transmission.

### Representative Conditional Semi-Persistent Reporting or Periodic Reporting

In certain representative embodiments, the WTRU may receive (e.g., first receive) signaling for semi-persistent (and/or periodic) CSI reporting, for example from or via a MAC CE and/or via RRC signaling). The WTRU may activate the semi-persistent CSI reporting and/or the WTRU may report periodic CSI reporting in a CSI reporting occasion when at least one additional condition is satisfied. The additional condition may include any of the above-described conditions. CSI reporting occasion herein may be generally referred to as a slot or a set of symbols where a WTRU may be configured to report a CSI.

For example, an additional condition may be that the WTRU receives a DCI triggering CSI reporting, such as UE-group common DCI described herein. In certain examples, the additional condition may be or may include that the WTRU receives a downlink assignment or downlink SPS activation with a certain priority indication in the DCI and/or corresponding SPS configuration. In other examples, the additional condition may include any of: (1) a WTRU being sent a NACK for a previous PDSCH, for example scheduled with a certain priority indication (e.g., a high priority, such as a priority index=1), (for example, the condition may apply until the WTRU receiving a retransmission of the PDSCH (e.g., the PDSCH with the same HARQ process identity) and/or the WTRU receiving a new data indicator (NDI) toggled for the same HARQ process identity); (2) no CSI reporting within a time window prior to the CSI reporting occasion for the same CSI-RS resource configured for the semi-persistent (and/or periodic) CSI reporting configured (e.g., the time window may a predefined number, configured via a higher layer signaling, and/or indicated dynamically in a number of symbols or slots); (3) an active bandwidth part (BWP) being switched within a time window prior to the CSI reporting occasion; and/or (4) one or more CSI reports being cancelled and/or dropped within a time window, for example due to an uplink scheduling cancellation; and/or (5) a WTRU having received a downlink assignment for the PDSCH with a TCI state which may be different from previous TCI state used for PDSCH scheduling, among others.

The WTRU may perform CSI measurements on CSI measurement resources configured for the semi-persistent or periodic reporting if (e.g., even if) the at least one additional condition is not satisfied, which for example may reduce latency for transmitting the CSI report. In certain representative embodiments, the WTRU may perform CSI measurements when (e.g., only when and/or on condition that) the at least one additional condition is satisfied, for example to allow reduction of overhead from CSI measurement resources and/or to save power. The timing and/or offset of CSI measurement resources may depend on the timing of the trigger condition. For example, the first CSI measurement resource occasion may occur a certain delay after reception of a DCI triggering the report. Such a delay, an offset and/or a timing may be fixed, configured as part of the CSI reporting configuration or dynamically indicated in the DCI

Autonomous Deactivation of Triggering Upon Meeting One or More Conditions (e.g., Timer Expiry and/or Reaching a Maximum Number of CSI Reports)

The WTRU may autonomously deactivate a trigger (e.g., triggering condition) or semi-persistent CSI reporting upon transmission of a CSI report triggered according to certain conditions (e.g., any of the conditions set forth herein). In addition, or alternatively, the WTRU may start a counter upon activation and/or initial transmission of a CSI report after activation and may increment the counter on condition that (e.g., every time) the CSI report is triggered and/or transmitted. The WTRU may autonomously deactivate the trigger condition when the counter reaches a maximum number of CSI reports.

The WTRU may start a timer upon reception of the signaling activating a trigger and/or a trigger condition for a CSI report or for semi-persistent CSI reporting. In addition, or alternatively, the WTRU may start a timer upon transmission and/or triggering of the first CSI report following activation of the trigger or reception of signaling for semi-persistent CSI reporting. Upon timer expiry, the WTRU may deactivate the trigger.

One of skill understands that activation/deactivation may include activation/deactivation of a trigger/trigger condition to for example enable triggering of a CSI report, if activated, when the trigger condition is satisfied/met or to delay and/or stop triggering of a CSI report, if deactivated, even when the trigger condition is satisfied/met.

For example, the maximum number of CSI reports and/or timer, if applicable, may be included as part of the CSI report configuration, signaled via DCI, signaling via RRC signaling and/or provided in the MAC CE.

The benefit of autonomous deactivation may include reduction of downlink signaling that may otherwise be required to stop the transmission of CSI reports when they are no longer used and/or required (e.g., after transmission of a traffic burst is completed).

### Representative Conditional Triggering of Aperiodic CSI Reporting

In certain representative embodiments, a WTRU may be configured with an aperiodic CSI (A-CSI) reporting configuration and an associated uplink resource (e.g., the PUSCH and/or the PUCCH) for the configured aperiodic CSI reporting. The aperiodic CSI reporting may be triggered when any of the following condition are met: (1) a WTRU receiving a downlink assignment or downlink SPS activation with certain priority indication in the DCI or corresponding SPS configuration; (2) a WTRU having received an uplink grant with a certain priority indication; and/or (3) an active bandwidth part (BWP) being switched (for example, the WTRU may report the pre-configured A-CSI reporting within a time window after an active BWP switch), among others.

The A-CSI reporting configuration may include a slot offset as a reporting offset (in time, based on an index and/or in a number of symbols, among others) and an associated uplink resource.

When there is a triggered A-CSI reporting based on the one or more conditions described herein and there is no configured uplink resource in the configured slot offset (e.g., the slot determined based on the slot offset is a downlink slot), the WTRU may perform any of the following: (1) the WTRU may determine a closest uplink slot later than the slot determined based on the slot offset and may include the configured uplink resource for A-CSI reporting in the closest uplink slot later than the determined slot; and/or (2) the WTRU may drop the triggered A-CSI reporting, among others.

### Representative Procedures Using Aperiodic CSI Reporting Resource

A WTRU triggered to send/report aperiodic CSI reports via a DL scheduling DCI may include the CSI report in the same feedback resource as the resource indicated for HARQ feedback. For example, the WTRU may use a feedback resource with a capacity to include both the HARQ feedback and a relevant CSI report. The CSI report may: (1) have a higher priority than other UCI (e.g., the CSI report may have a priority equal to the priority of the HARQ feedback) or have a predefined priority.

In certain representative embodiments, the WTRU may transmit the CSI report and the HARQ feedback in different resources. In such case, the resource or resources for the CSI report may be indicated by a PUCCH resource indicator (PRI), for example in a CSI report configuration and/or in a MAC CE activating the reporting. The PRI may be a field (e.g., an additional field) in the DCI, or may be the same field as for the resource for HARQ-ACK. For example, RRC signaling may configure a first resource for HARQ-ACK and a second resource for CSI reporting for at least one value of the PRI, and may be implemented, for example, by one or more information elements (e.g., new information elements and/or resource sets) for example for CSI reporting in a PUCCH configuration. The WTRU may determine to multiplex HARQ-ACK and CSI in the same resource, if the value of PRI is mapped to a single resource, or may determine to transmit HARQ-ACK and CSI in different resources, if the value of PRI is mapped to a single resource. In certain embodiments, the WTRU may determine to not report CSI, if the value of PRI is mapped to a single resource. In case the value of PRI is mapped to a single resource, the WTRU may determine whether to transmit HARQ-ACK (e.g., only HARQ-ACK) in the resource or to multiplex HARQ-ACK and CSI in the resource based on higher layer signaling, such as MAC CE or RRC configuration.

In certain representative embodiments, the WTRU may determine whether to transmit HARQ-ACK and CSI in the same resource based on whether or not resources indicated for HARQ-ACK and CSI overlap. On condition that the resources overlap, the WTRU may multiplex on any of: (1) the resource or resources indicated for HARQ-ACK and/or (2) the resource or resources indicated for CSI: (i) according to one or more pre-defined rules and/or (ii) depending on criteria such as PUCCH format, available payload, and/or a timing of a first symbol, among others.

A WTRU may be configured with PUCCH resources to report the triggered aperiodic and/or semi-persistent CSI reports. For example, the WTRU may have a configuration for PUCCH resources that may be activated when (e.g., only when) resources for DL and/or UL transmissions of priority (e.g., having high priority data) are activated. For example, a WTRU may be configured with one or more reporting resources as described herein to report the triggered aperiodic CSI reports.

In certain representative embodiments, the WTRU may be configured with one or more PUCCH resources that may be dynamically activated and may be used (e.g., only be used) when activated by a network entity (e.g., the network). The WTRU may determine that one or more PUCCH resources are dynamically activated when aperiodic CSI report is triggered (e.g., at the same time as when the aperiodic CSI report is triggered). For example, if a trigger criterion/triggering mechanism criterion is satisfied, the WTRU may determine/consider one or more associated PUCCH resources to be activated.

The relationship between the timing of an aperiodic CSI report triggering event and the timing of an associated PUCCH resource may be configurable. In certain examples, the WTRU may have pre-configured timing instances for dynamically activated PUCCH resources, and/or may determine/consider the first available PUCCH resource, upon or in response to and/or after a triggering condition being met, to be dynamically activated. The PUCCH resource may not be used for any other UCI transmission that does not include the triggered aperiodic CSI.

In certain examples, the WTRU may be configured with resources for a dynamically activated PUCCH. The configuration may include parameters (e.g., all essential parameters) and may not include a time allocation. The WTRU may determine the time allocation as a function of a parameter of the aperiodic CSI report trigger (e.g., as a function of the timing of the aperiodic CSI report trigger).

A WTRU triggered to report aperiodic CSI for one or more priority transmissions (e.g., for high priority transmissions) may: (1) transmit aperiodic CSI on a first UL resource and/or (2) terminate the aperiodic CSI on the first UL resource from any of: (i) the HARQ feedback resource associated with the DL transmission; (ii) the PUSCH resource scheduled by the DCI or configured by higher layers; (iii) a dynamically activated PUCCH resource; and/or (iv) a regular PUCCH resource, among others.

The WTRU may select the appropriate resource for reporting triggered aperiodic CSI based on the contents of the aperiodic CSI. For example, if the WTRU is triggered to report CSI and the CSI has not changed (e.g., changed much) compared to a previously transmitted CSI report or the last CSI report, the WTRU may be restricted on the set of possible resources, channels and/or resource type to transmit the CSI report.

In certain examples, the WTRU may select a specific resource to implicitly indicate part of the CSI. For example, the WTRU may report CSI for a sub-band of the entire BWP. The WTRU may use a PUCCH resource that implicitly indicates one or more sub-band associated with the CSI report (e.g., what sub-band or sub-bands the CSI report is for).

### Representative Configuration of Enhanced CSI Triggering

The WTRU may determine that a CSI report is triggered or is to be triggered based on an information element of the corresponding CSI reporting configuration (for example, a new value of a reportConfigType information element). For example, when an enhanced CSI triggering is based on semi-persistent CSI reporting on PUCCH, at least one information element (e.g., new information element) within semiPersistentOnPUCCH may be signaled to provide additional parameters specific to the enhanced triggering scheme. In certain representative embodiments, the configuration may be indicated as part of the aperiodic CSI trigger state.

### Representative Priority Applicable to Enhanced CSI Trigger

When the WTRU transmits a CSI report based on one of the above triggers and/or configurations, the WTRU may determine a priority indication applicable to the CSI and/or the PUCCH resource or resources carrying the CSI, based on the following: (1) a priority indication for HARQ-ACK indicated or implicitly determined from the DCI containing/including the PDSCH assignment and/or a SPS activation/release; (2) a priority indication included in group-common DCI triggering the report; (3) a priority indication indicated in a MAC CE activating a corresponding semi-persistent CSI reporting configuration, or in a MAC CE activating the trigger for the CSI; and/or (4) a priority indication configured as part of the CSI report configuration.

### Representative Procedures for CSI Reporting by Resource Selection

Representative Procedures for Grant Selection Based on Channel Conditions, MCS and/or TBS

For type-1 CGs, a semi-static MCS may be configured, which may often be configured conservatively and may result in a low spectral efficiency. For type-2 CGs and DL SPS, the MCS may be changed by (e.g., only by) de-activating and then re-activating one or more resources by a different DCI, and, for example, the WTRU may not adapt or may not adapt well to channel variations.

The WTRU may be configured with a number of UL reporting resources to: (1) report CSI and/or UCI, (2) transmit UL data, and/or (3) transmit MAC CEs. The reporting resources may any of: (1) overlap in any of: the time and frequency domains, the time domain, the frequency domain, and/or the code domain, (2) overlap in a subset of the aforementioned domains, and/or (3) not overlap at all. Reporting resource may be configured on one or more UL carriers. Reporting resource may be configured on a normal UL (NUL), a supplemental UL (SUL), or both ULs. A reporting resource may be a PUSCH resource (e.g., a CG or a Dynamic Grant (DG)), a PUCCH resource (e.g., a PUCCH time/frequency resource), a PUCCH format, a coded sequence for PUCCH, or an SR configuration), a PRACH resource (e.g., a subset of PRACH occasions and/or preambles), and/or an SRS configuration or resource. One resource, a portion of the resources, or each resource may be configured semi-statically with a time/frequency allocation and/or a periodicity. A reporting resource may be configured with an SRS and/or DM-RS configuration, which may be used for identification or blind decoding.

From a plurality of available reporting resources, the WTRU may select a reporting resource, if the selected reporting resource satisfies the configured applicability criteria, if any, when each configured applicability criterion meets a configured threshold and/or a configure range.

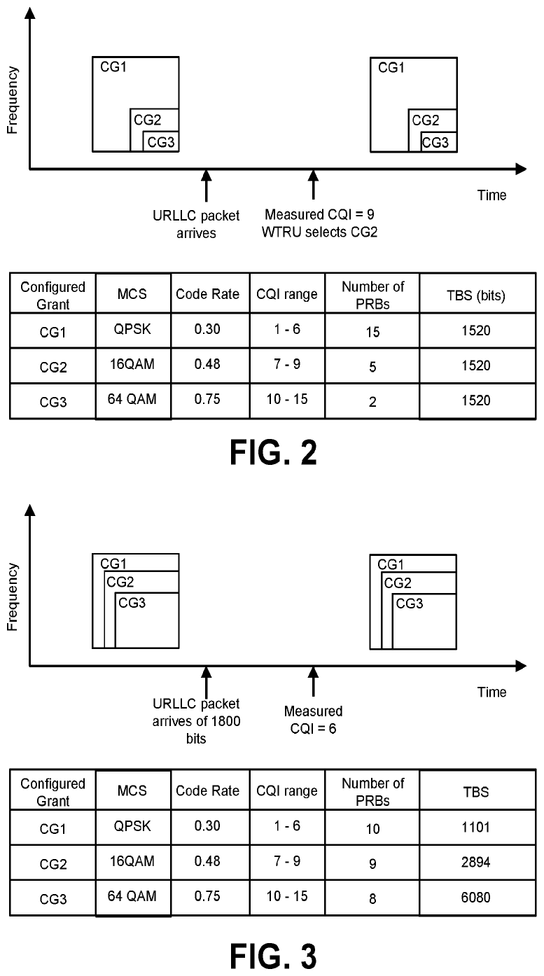

FIG. 2 is a diagram illustrating a representative CG selection procedure.

Referring to FIG. 2, for a scenario in which a WTRU 102 has several CGs on which the WTRU 102 may report CQI, the WTRU 102 may measure CQI prior to selecting a CG. The WTRU 102 may select the CG that maps to the measured CQI (e.g., the CG that has a measured CQI in a CQI range associated with the CG). The CQI range may be configured by RRC signaling.

For example, the WTRU 102 may have a number of CGs (e.g., CG1, CG2 and CG3). A URLLC packet may arrive at a buffer (e.g., a buffer of the WTRU 102). Based on the measured CQI, the UE may map the URLLC packet to CG2. As shown in FIG. 2, a measured CQI in a first range (e.g., range 1-6) may map to CG1. The measured CQI in a second range (e.g., range 7-9) may map to CG2. The measured CQI in a third range (e.g., range 10-15) may map to CG3.

Although 3 CGs with 3 measured CQI ranges are shown any number of such CGs/ranges are possible.

Each CG may have associated transmission parameters. For example: (1) the CG1 may have a MCS corresponding to QPSK, a code rate of 0.30, a number of PRBs of 15 and a Transport Block Size of 1520 bits; (2) the CG2 may have a MCS corresponding the 16 QAM, a code rate of 0.48, a number of PRBs of 5 and a Transport Block Size of 1520 bits; and (3) the CG3 may have a MCS corresponding the 64 QAM, a code rate of 0.75, a number of PRBs of 2 and a Transport Block Size of 1520 bits.

The WTRU 102 may be configured (e.g., by RRC signaling) and/or may be specified with a mapping between a reporting resource and any of the applicability criteria as follows:
(1) a measured CSI and/or CSI range,
   (for example, the network (e.g., a network entity) may configure a CQI range for a given reporting resource. The WTRU 102 may select a reporting resource, if the measured CQI is or falls within the configured CQI range for that reporting resource. The same behavior can be applied for a Rank Indicator (RI) or a Precoding Matrix Indicator (PMI));
(2) a measured channel condition and/or a channel condition range associated with a channel condition as set forth herein,
   (for example, the WTRU 102 may select a reporting resource, if the measured power headroom, RSRP and/or SINR is less than a configured threshold, or within a configured range for that reporting resource).
(3) a BLER level,
   (for example, the WTRU 102 may map a measured L1-SINR to a BLER level for the reporting resource, based on the configured MCS (e.g., semi-statically configured MCS) for the CG and/or link-level mappings corresponding to the configured MCS. The WTRU 102 may select the CG, if the determined BLER level is lower than a certain threshold or within a certain range (e.g., which can be configured, signaled, or determined, for example based on a transmission priority));
(4) a number of bits, and/or a maximum number of bits that is to be reported as part of the CSI and/or UCI,
   (for example, the WTRU 102 may determine/consider the reporting resource, if the number of CSI bits is less than or equal a certain configured threshold);
(5) a number of data bits included in a TB on which the CSI and/or UCI is to be multiplexed, (for example, the WTRU 102 may select a certain PUSCH resource, if the TBS and/or the high priority unsegmented Medium Access Control Service Data Unit (MAC SDU) exceeds a configured threshold (e.g., is less than or greater than a certain configured threshold). In another example, the WTRU 102 may select a reporting resource that does not meet a configured CQI range, if the selection results in no segmentation (or no segmentation of packets of a certain priority (e.g., a high priority packet), and maybe further conditioned on the probability of retransmission (e.g., possibly provided that a probability of the retransmission is less that a certain threshold). The WTRU 102 may estimate the probability of a NACK based on the configured MCS for the CG and/or the L1 measurements (e.g., L1 SINR), e.g., by considering, and/or looking for a BLER value from a link level mapping of a measured SINR to determine a BLER value estimate. The WTRU 102 may further consider the number of padding bits. For example, the WTRU 102 may select a certain resource, if the TBS is larger than a configured threshold and/or the number of padding bits is lower than a certain threshold);
(6) the type of information/UCI to report (e.g., whether the information to report is CSI, HARQ feedback, a MAC CE type, and/or a combination thereof);
(7) a number of resource blocks (e.g., a number of PRBs);
(8) a LCH, a LCG, and/or a DRB,
   (for example, the RRC may configure a reporting resource with a LCH selection restriction. The WTRU 102 may select the associated reporting resource, if the WTRU 102 has buffered data from a LCH associated with the reporting resource, and/or if the reported CSI or reported UCI is associate with a LCH associated with the reporting resource);
(9) a service, a priority, a reliability level, and/or a Radio Network Temporary Identifier (RNTI) associated with a reliable MCS table,
   (for example, the WTRU 102 may determine/consider reporting resources (e.g., only reporting resources) configured to report measurement quantities (e.g., CSI and/or UCI) associated with a certain priority level and/or a service. For example, the WTRU 102 may be configured with a mapping between one or more priority levels and a subset of the reporting resources. The WTRU 102 may associate certain measurements such as CSI, and/or UCI (e.g., HARQ-ACK for prioritized transmissions) with one or more priority levels. In certain examples, the WTRU 102 may select a CG that meets a minimum reliability level (e.g., required reliability level and/or BLER) associated with a priority LCH and/or MAC SDU (e.g., a highest priority LCH or highest priority MAC SDU). The WTRU 102 may select the CG that meets the minimum reliability level based on whether the MAC SDU is to be segmented (e.g., by selection of CGs which do not require the MAC SDUs to be segmented);
(10) a processing time or a time-domain function,
   (for example, a time interval/quantity that may be measured and/or reported, a time since data arrival, or a time since a last transmission on the same bearer. For example, the WTRU 102 may determine/consider a reporting resource for selection, if the reporting resource can produce a TB which allows for at least a minimum TB preparation time before the first UL symbol of the reporting resource. In another example, the WTRU 102 may determine/consider a subset of reporting resources based on the processing pipeline associated with the reported measurement and/or data. In another example, the WTRU 102 may determine/consider a reporting resource valid for selection, if the time from a certain quantity (e.g., CSI and/or UCI) is measured and/or determined and the first or last UL symbol of the reporting resource is less than a certain threshold, where such threshold can be configured, predetermined as function of the WTRU 102 capability, and/or determined as a function of the service priority or an associated priority level. The WTRU 102 may select a reporting resource based on a remaining survival time. For example, the WTRU 102 may select a more reliable CG (e.g., the CG with a most reliable MCS, and/or the CG with the least configured CQI range), if the remaining survival time is less than a threshold);
(11) a frequency domain function,
   (for example, a BWP, a carrier, a SUL, a NUL, and/or a numerology. For example, the WTRU 102 may determine/consider reporting resources (e.g., only reporting resources) configured in the active UL BWPs and/or UL carrier or UL carriers. In other examples, the WTRU 102 may measure and/or report some quantities outside the active BWP and/or one or more carriers. The WTRU 102 may be configured with a mapping between a certain BWP, certain BWPs, one or more carriers and reporting resources. The WTRU 102 may select the reporting resources (e.g., only the reporting resources) mapped to the one or more BWPS and/or one or more carriers on which the measurements were made);
(12) a measurement accuracy and/or reliability,
   (for example, the WTRU 102 may determine/consider a reporting resource, if the measured quantity that can be reported has an accuracy exceeding (e.g., above or below) a certain threshold. Accuracy may be taken as a function of the granularity of the measurement and/or the number of bits. Related measurements may be subject to a configured accuracy requirement, which can be different from typical measurements of the same nature);
(13) a DL resource and/or DL assignment,
   (for example, the WTRU 102 may determine to report and/or consider reporting UCI and/or CSI on a certain UL reporting resource or reporting resources, after the WTRU 102 receives one or more DL assignments on a given DL resource (e.g., the DL resource may be determined as a function of the DL resource allocation, BWP, and/or carrier. The association may be configured, for example by higher layers (e.g., RRC signaling). In certain examples, the WTRU 102 may determine to report and/or consider reporting UCI and/or CSI on a certain UL reporting resource or reporting resources, after the WTRU 102 receives activation signaling for an associated DL SPS resource. The association may be configured by higher layers (e.g., RRC signaling));
(14) whether associated data is for a retransmission or a new transmission,
   (for example, the WTRU 102 may select (e.g., only select) a reporting resource that matches the TBS of the retransmitted TB. In certain examples, the WTRU 102 may select (e.g., only select) one or more reporting resources when the associated data is for a new transmission);
(15) a function of the HARQ operating point, e.g., the CG timer and/or expected retransmission time;
(16) speed and/or level of channel variation in time,
   (for example, the WTRU 102 may determine to report and/or consider reporting UCI and/or CSI on a certain UL reporting resource or reporting resources, if the measured WTRU speed exceeds a certain threshold (e.g., is higher than or lower than a certain configured threshold), or if measured variation in channel conditions (e.g., based on CQI and/or RSRP) within a period of time exceeds a threshold (e.g., is larger than a certain threshold)); and/or
(17) a function of receiving and/or satisfying an aperiodic CSI reporting trigger, as described herein,
   (for example, the WTRU 102 may determine and/or consider a reporting resource applicable upon, in response to and/or after satisfying any or a subset of the CSI reporting triggers), among others.

The WTRU 102 may exclude reporting resource that do not meet the applicability criteria. If multiple reporting resources meets the reporting applicability criteria, the WTRU 102 may select any of: (1) a first occurring resource in time; (2) a resource associated with the least latency; (3) a resource with first occurring last UL symbol; (4) a resource with the least duration; and/or (5) any of the applicable reporting resources.

In some examples, a reporting resource may satisfy some but not all of applicability criteria or may satisfy all applicability criteria, if a prioritized MAC SDU is segmented. In scenarios in which no reporting resource meets all of the applicability criteria, the WTRU 102 may select the resource with a minimum violation of the applicability criteria. The WTRU 102 may not strictly enforce the configured applicability criteria. For example, the WTRU 102 may select a resource with a least distance from meeting the applicability criteria. Each applicability criterion violation may be weighted when computing this distance. In certain examples, the WTRU 102 may select the reporting resource (e.g., a CG) associated with the least overall latency or HARQ Round Trip Time (RTT) for transmission of buffered data (e.g., high priority data), while determining/considering probabilities of retransmissions and/or time until the whole MAC SDU is transmitted. Detailed examples are provided herein.

### Representative Procedures for Activation or Deactivation of Reporting Resources

In certain representative embodiments, the WTRU 102 may activate a certain DL SPS resource associated with a selected UL reporting resource. For example, the WTRU 102 may be configured by RRC signaling with an association mapping between or among one or more DL SPS resources and one or more UL CGs. The WTRU 102 may activate a certain UL reporting resource or certain UL reporting resources associated with the DL SPS resource, e.g., after reception of a DL assignment on the one or more DL SPS resources and/or after activating the associated DL SPS resources. For example, after reception of a DL assignment on a certain DL SPS resource, the WTRU 102 may activate one or more associated UL reporting resources, measure the associated CSI-RS, and/or report measured CSI and/or UCI on the applicable one or more associated UL reporting resources.

In certain embodiments, the WTRU 102 may deactivate one or more reporting resources, if associated one or more measurement resources (e.g., CSI-RS for CSI reports or associated HARQ processes for UCI feedback) are deactivated. For example, for a reporting resource configured with applicability criteria associated with CQI, the WTRU 102 may deactivate associated reporting resources (one, a subset, or all associated reporting resources), after reception of a MAC CE deactivating the associated resources (e.g., the CSI-RS resources).

In certain embodiments, the WTRU 102 may deactivate normal reporting resources (e.g., legacy and/or conventional periodic reporting on the PUCCH) after activating an alternative reporting resource. In other embodiments, the WTRU 102 may activate normal reporting resources (e.g., legacy and/or conventional periodic reporting on the PUCCH), after deactivating an alternative reporting resource.

The WTRU 102 may receive dynamic signaling, e.g., by DCI and/or by a MAC CE, that may activate or deactivate one or more reporting resources for the WTRU 102. The WTRU 102 may transmit on the one or more activated reporting resources (e.g., only on the one or more activated reporting resources). The WTRU 102 may receive dynamic signaling, e.g., by DCI or by a MAC CE, that may override the configured applicability criteria for the one or more reporting resources. For example, the WTRU 102 may receive an activation DCI for a type-2 CG, which may indicate a new CSI range and/or threshold for the WTRU 102 to apply part of the applicability criteria for grant selection. In some examples, the WTRU 102 may receive a DCI that may override the configured or indicated MCS for a CG and/or a DL SPS resource, which may be an activation DCI. The WTRU 102 may generate a confirmation MAC CE after reception of the dynamic signaling, for example to confirm successful reception of the new applicability criteria.

FIG. 3 is a diagram illustrating another representative CG selection procedure.

Referring to FIG. 3, in the CG selection procedure, the WTRU 102 may have several CGs (e.g., CG1 and CG2) that the WTRU 102 may select and each CG (e.g., CG1 and CG2) may be configured with a CQI applicability criterion and a max TBS applicability criterion. The URLLC MAC SDU may be 1800 bits and the measured CQI may be 6. CG1 may meet the applicability criteria, for example assuming segmentation is possible. If the WTRU 102 selects CG2, the high priority packet may not be segmented and there may be a slight risk of retransmission (e.g., due to a NACK). In certain examples, the WTRU 102 may select CG2, if {Prob^{CG2}(NACK)×Time till the next retransmission occasion} is less than {Prob^{CG1}(NACK)×Time till the next retransmission occasion+time until remaining segmented MAC SDUs are transmitted}. The WTRU 102 may estimate a probability of the NACK based on the configured MCS for the CG and/or L1 measurements (e.g., based on L1 SINR), e.g., by determining a BLER value (e.g., via a look up from a link level mapping of a measured SINR to a BLER value estimate).

For example, the WTRU 102 may have a number of CGs (e.g., CG1, CG2 and CG3). The packet (e.g., a URLLC packet) may arrive at a buffer (e.g., a buffer of the WTRU 102). Based on the measured CQI, the UE may map the URLLC packet to CG1. As shown in FIG. 3, a measured CQI in a first range (e.g., range 1-6) may map to CG1. The measured CQI in a second range (e.g., range 7-9) may map to CG2. The measured CQI in a third range (e.g., range 10-15) may map to CG3.

Although 3 CGs with 3 measured CQI ranges are shown any number of such CGs/ranges are possible.

Each CG may have associated transmission parameters. For example: (1) the CG1 may have a MCS corresponding to QPSK, a code rate of 0.30, a number of PRBs of 10 and a Transport Block Size of 1011 bits; (2) the CG2 may have a MCS corresponding the 16 QAM, a code rate of 0.48, a number of PRBs of 9 and a Transport Block Size of 2894 bits; and (3) the CG3 may have a MCS corresponding the 64 QAM, a code rate of 0.75, a number of PRBs of 8 and a Transport Block Size of 6080 bits.

The selection of the CG may include any of the following:
(1) UL data may arrive at a buffer (e.g., a buffer of the WTRU 102);
(2) the WTRU 102 may measure an L1 SINR;
(3) the WTRU 102 may determine a BLER level for an available/applicable reporting resource (e.g., each available/applicable reporting resource) based on the MCS associated with the UL resource (e.g., each UL resource);
(4) the WTRU 102 may exclude one or more reporting resources that correspond to a BLER level higher than a threshold corresponding to the higher priority LCH with buffered data, (for example where the threshold may be a function of the service or a configured reliability level per DRB/LCH);
(5) from the set of reporting resources that meet the BLER level, the WTRU 102 may select the one or more resources that leads to not segmenting MAC SDUs associated with high priority/reliability services.
(6) the WTRU 102 may evaluate latency (transmitting TB with a certain BLER) vs. latency of segmenting the MAC SDU into more than one segment. For example, the WTRU 102 may compute an overall latency estimate for each reporting resource and may select the reporting resource associated with a lowest overall latency. For the sake of illustration, transmitting a single MAC SDU on a given UL resource R can have an estimated latency of:

$${E ( Latency )}^{R} = {\sum }_{s = 1}^{\# of segments} ( {\sum }_{i = 1}^{max \# of retx} P r o {b}_{N A C K}^{R} ( i , s ) \times Retx time ( i , s ) ) + Δ t ( s ) \\ Δ t ( s ) = E ( time from SDU arrival until an initial transmission of segment s )$$

### Representative Procedures for Latency Reduction of CSI Reporting

### Representative Multiple CSI Reporting Patterns/Configurations

The WTRU 102 may be configured with one or more CSI reporting patterns, configurations, and/or cycles, (herein sometimes collectively referred as CSI reporting patterns). A CSI reporting pattern may be depicted as a CSI reporting configuration, which may be associated with one or more UL reporting resources and/or one or more CSI-RS resources.

The WTRU 102 may have an association between a CSI reporting pattern and a set of corresponding RS measurement opportunities. In one example, the WTRU 102 may assume that the set of RS measurement opportunities is given by the CSI reporting pattern in time. For example, a CSI reporting pattern may be applied as a mask to the set of resources used for CSI measurement, where the WTRU 102 may assume that resource is present if (e.g., only if) it overlaps in time with the time pattern corresponding to the CSI reporting pattern.

A CSI reporting pattern may be configured with at least one of the following: (1) a time domain offset (e.g., a start offset from a slot boundary); (2) a periodicity (e.g., in slots, symbols, or absolute time), (3) a frequency domain granularity for which CSI measurements are reported (e.g., one out of N PRBs, where N is a positive integer, every PRB, or every other PRB, among others); (4) an associated frequency domain allocation for which CSI measurements are reported (e.g., a BWP allocation, a carrier allocation, and/or a sub-band allocation, among others); (5) an associated UL reporting resource (e.g., a PUCCH resource or a CG); (6) one or more inactivity timers (e.g., in slots, symbols, and/or absolute time); (7) one or more associated CSI-RSs; (8) one or more associated CSI-RS resource sets; (9) one or more associated UL and/or DL data resources; (10) whether the CSI reporting pattern may be triggered by a periodic reporting mechanism/function; and/or (11) whether the CSI reporting pattern is the default configuration.

A CSI reporting pattern may be configured with: (1) one or more associated priorities; (2) one or more priority indexes/levels; (3) one or more LCHs; (4) one or more LCGs; (5) one or more DRBs; (6) a reliability level; (7) a latency level and/or threshold; and/or (8) other more general services. A CSI reporting pattern may be configured with one or more associated DRX configurations and/or cycles.

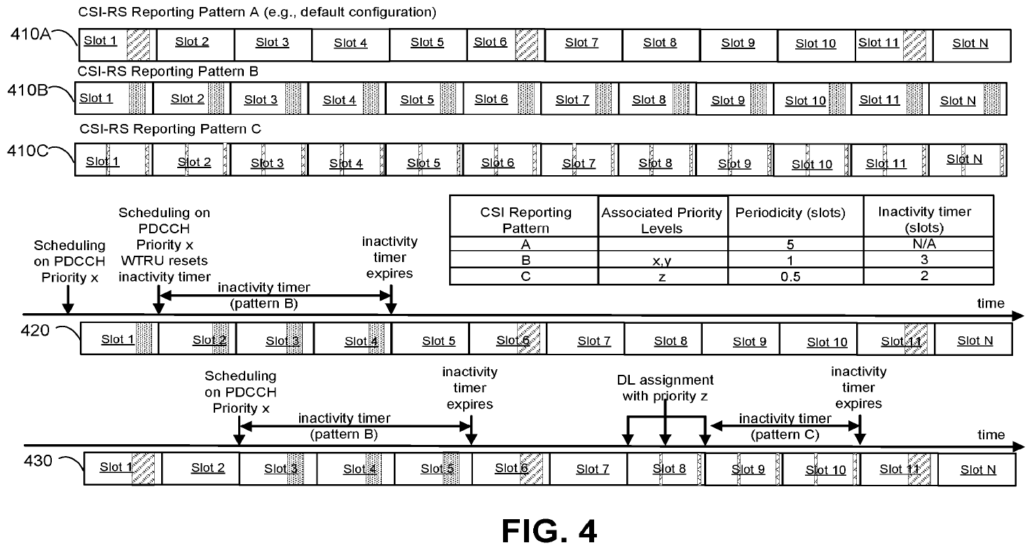

FIG. 4 is a diagram illustrating a WTRU 102 configured with multiple (e.g., three) CSI reporting patterns and an example of switching between the configured reporting patterns.

Referring to FIG. 4, a frame format may include a plurality of slots (e.g., slots 1, slot 2 . . . slot N). The WTRU 102 may have any number (e.g., three) configured CSI reporting patterns 410A, 410B and 410C. CSI reporting pattern 410A: (1) may be a default configuration; (2) may have a CSI-RS periodicity of once every 5 slots (e.g., slot 1, slot 6, and slot 11 . . . ); and/or (3) may not have an associated inactivity timer. CSI reporting pattern 410B: (1) may have associated priority levels x and y; (2) may have a CSI-RS periodicity of once per slot (e.g., slot 1, slot 2, . . . slot N); and/or (3) may have an associated inactivity timer of 3 slots (e.g., the inactivity timer has an expiry after 3 slots). CSI reporting pattern 410C: (1) may have an associated priority level z; (2) may have a CSI-RS periodicity of 2 per slot (first and second CSI reporting occasions occurring in each slot 1, slot2 . . . slot N); and/or (3) may have an associated inactivity timer of 2 slots (e.g., the inactivity timer has an expiry after 2 slots).

Although certain periodicities and inactivity intervals/expiry periods are illustrated, others (e.g., other combinations) are equally possible.

In certain embodiments, a WTRU 102 may switch among CSI reporting patterns for the triggering of CSI reporting.

As illustrated in 420, the WTRU 102 may switch from CSI reporting pattern 410B for slots 1-5 to CSI reporting pattern 410A for slots 6-N. For example, the scheduling on the PDCCH, prior to slot 1, may have a priority level x and a CSI reporting pattern 410B may be used. The scheduling on the PDCCH, at the end of slot 1, may have a priority level x, the WTRU may reset the inactivity timer and a CSI reporting pattern 410B may be used. At the end of slot 4 (e.g., 3 slots after reset of the inactivity timer), the inactivity timer may expire. The CSI reporting pattern 410A may be used after slot 4 (e.g., the default pattern), because there is no priority level associated with the scheduled PDCCH. For example, the WTRU 102 may switch the CSI reporting pattern (e.g., from the CSI reporting pattern 410B to the CSI reporting pattern 410A).

As illustrated in 430, the WTRU 102 may: (1) switch from the CSI reporting pattern 410A for slots 1 and 2 to the CSI reporting pattern 410B for slots 3-5; (2) switch again to the CSI reporting pattern 410A for slots 6 and 7; (3) further switch to the CSI reporting pattern 410C for slots 8-10; and/or (4) further switch to the CSI reporting pattern 410A for slot 11. For example, the scheduling on the PDCCH, prior to slot 1, may have no associated priority level and a CSI reporting pattern 410A may be used. The scheduling on the PDCCH, at the end of slot 2, may have a priority level x, the WTRU 102 may reset the inactivity timer and a CSI reporting pattern 410B may be used. At the end of slot 5 (e.g., 3 slots after reset of the inactivity timer), the inactivity timer may expire. The CSI reporting pattern 410A may be used after slot 5 (e.g., the default pattern), because there is no priority level associated with the scheduled PDCCH. During slot 8, one or more downlink assignments may be received by the WTRU 102 with an associated priority z, the WTRU 102 may reset the inactivity timer for 2 slots and the CSI reporting pattern 410C may be used. At the end of slot 10 (e.g., 2 slots after reset of the inactivity timer), the inactivity timer may expire. The CSI reporting pattern 410A may be used after slot 10 (e.g., the default pattern), because there is no priority level associated with the scheduled PDCCH.

For example, the WTRU 102 may: (1) switch between or among the configured CSI reporting patterns 410A, 410B and 410C, (2) activate a given CSI reporting pattern 410A, 410B and/or 410C and/or may deactivate a given CSI reporting pattern 410A, 410B or 410C based on any of the following triggers:
(1) reception of dynamic indication (e.g., by DCI and/or MAC CE),
   (for example, the WTRU 102 may switch between/among configured CSI reporting patterns, may activate a given CSI reporting pattern, and/or may deactivate a given CSI reporting pattern, after reception of a dynamic indication by DCI and/or MAC CE. The indication may include certain CSI reporting patterns to active, deactivate, switch from and/or switch to. In certain examples, the WTRU 102 may switch to a given CSI reporting pattern after reception of an aperiodic CSI reporting request indicating the pattern itself and/or a parameter associated with the CSI reporting pattern by configuration. In other examples, the WTRU 102 may switch to a given CSI reporting pattern, may activate a given CSI reporting pattern, and/or may deactivate a given CSI reporting pattern, after reception of an aperiodic CSI reporting request);
(2) DCI reception with an associated priority level,
   (for example, the WTRU 102 may, after reception of a dynamic indication by DCI with a priority level that is associated with the CSI reporting pattern: (1) switch to one or more configured CSI reporting patterns, and/or (2) activate a given CSI reporting pattern. In certain examples, the WTRU 102 may: (1) switch to a certain configured CSI reporting pattern, and/or (2) activate a given CSI reporting pattern, after reception of a DL assignment and/or an UL grant with a priority level, a LCH, a LCG, and/or a DRB that is associated with the CSI reporting pattern);
(3) UL transmission on one or more resources (e.g., certain resources),
   (for example, the WTRU 102 may switch to certain configured CSI reporting patterns (e.g., one or more configured CSI reporting patterns), and/or activate a given CSI reporting pattern, after a transmission of UL data and/or UCI on a given UL resource associated with the CSI reporting pattern (e.g., an UL transmission on one or more resources associated with a DL SPS resource). The association can be configured by higher layers (e.g., RRC signaling));
(4) DL transmission on certain resources (e.g., one or more resources),
   (for example, the WTRU 102 may switch to a certain configured CSI reporting patterns (e.g., one or more configured CSI reporting patterns), and/or may activate a given CSI reporting pattern, after reception of DL data on a DL resource associated with the CSI reporting pattern (e.g., a DL SPS resource associated with a DL SPS resource). The association can be configured by higher layers (e.g., RRC signaling));
(5) activate and/or deactivate an associated resource,
   (for example, the WTRU 102 may switch to certain configured CSI reporting patterns (e.g., one or more configured CSI reporting patterns), may activate a given CSI reporting pattern, and/or may deactivate a given CSI reporting pattern, after reception of an activation or deactivation DCI for an associated UL or DL resource. For example, the WTRU 102 may activate a certain CSI reporting pattern, after receiving an activation DCI for an associated DL SPS resource);
(6) based on a timer and/or a counter (e.g., expiry of an inactivity time and/or elapsed time since applicable scheduling).
   (for example, the WTRU 102 may maintain an inactivity counter and/or a timer for a non-default CSI reporting pattern (e.g., each non-default CSI reporting pattern). The WTRU 102 may switch to certain configured CSI reporting patterns (e.g., one or more configured CSI reporting patterns), may activate a given CSI reporting pattern, and/or may deactivate a given CSI reporting pattern, after the expiry of an inactivity timer associated with the CSI reporting pattern. The WTRU 102 may start the inactivity timer after reception of scheduling DCI and/or a MAC CE associated with the CSI reporting pattern. If the CSI reporting pattern is associated with a certain priority (e.g., a priority index, a LCH, a LCG and/or a DRB, among others), the WTRU 102 may restart the inactivity timer when (e.g., each time) the WTRU 102 is scheduled (e.g., with a DL assignment and/or UL grant) and/or receives a DCI with the associated priority. After expiry of the inactivity timer, the WTRU 102 may switch to the default CSI reporting pattern as shown in FIG. 4. In certain examples, the RRC (e.g., via RRC signaling) may configure a different pattern to switch to after timer expiry for a CSI reporting pattern (e.g., each CSI reporting pattern). After expiry of the inactivity timer, the WTRU 102 may switch to the CSI reporting pattern configured to be switched to after timer expiry. In other examples, the WTRU 102 may activate a certain reporting pattern, if the time since the channel that was last acquired with successful LBT is larger than a certain threshold. The WTRU 102 may achieve the pattern switching based on a counter (e.g., instead of a timer), such that the actions carried at timer expiry are performed after reaching a certain count threshold and the counter may be reset after or each time the WTRU 102 is scheduled with applicable DCI. For example, the WTRU 102 may reset the inactivity counter after reception of scheduling DCI and/or a MAC CE associated with the CSI reporting pattern and/or with the associated priority. The WTRU 102 may increment the counter after or each time the WTRU 102 reports the CSI for the associated CSI reporting pattern. Once the counter reaches a configured threshold, the WTRU 102 may switch to the configured default CSI reporting pattern);
(7) UL data arrival for a certain service/LCH/DRB in the WTRU 102 buffer, (for example, the WTRU 102 may activate a given CSI reporting pattern, after UL data arrives at the buffer of the WTRU 102 for a priority, a priority index/level, a LCH, a LCG, a DRB, a reliability level, a latency level and/or threshold, and/or a service associated with the CSI reporting pattern. In certain embodiments, the WTRU 102 may activate a given CSI reporting pattern, after the WTRU 102 triggers a new SR for a LCH, an LCG, and/or a SR configuration associated with the CSI reporting pattern);
(8) based on channel conditions (e.g., RSRP, SINR, RSSI, Power Headroom (PH), Exposure Headroom (EH), Channel Occupancy (CO) and/or CQI),
   (for example, the WTRU 102 may switch to a certain configured CSI reporting pattern, activate a given CSI reporting pattern, and/or deactivate a given CSI reporting pattern, if the measured one or more channel conditions (e.g., RSRP, SINR, RSSI, PH, EH, CO and/or CQI) and/or a change in the measured one or more channel conditions since the last measurement exceeds a configured, predetermined or signaled threshold (e.g., is less than or greater than, for example a configured threshold);
(9) activation or deactivation of associated CSI-RS resources,
   (for example, the WTRU 102 may switch to a certain configured CSI reporting pattern, activate a given CSI reporting pattern, and/or deactivate a given CSI reporting pattern, if the associated CSI-RS resources or CSI resource set is activated or deactivated. The WTRU 102 may deactivate or reactivate a CSI reporting resource upon, in response to or after an RRC configuration or reconfiguration of associated CSI-RS resources and/or CSI resource sets);
(10) activation status of an associated DRX configuration and/or cycle,
   (for example, the WTRU 102 may be configured with an association between or among one or more DRX configurations and a CSI reporting pattern. The WTRU 102 may activate a given CSI reporting pattern upon, in response to or after activation of the associated DRX configuration or configurations, and/or may deactivate a given CSI reporting pattern upon, in response to or after deactivation of the associated DRX configuration or configurations. For example, the WTRU 102 may be configured or predetermined to activate or deactivate a subset of CSI reporting patterns during an inactive time and/or while certain Discontinuous Reception (DRX) timers are running (e.g., the DRX HARQ or retransmission timers));
(11) speed and/or level of channel variation in terms of fast fading,
   (for example, the WTRU 102 may switch to a certain configured CSI reporting pattern, may activate a given CSI reporting pattern or deactivate a given CSI reporting pattern, if the measured WTRU speed exceeds a threshold (e.g., is higher than or lower than a certain configured, predetermined, or signaled threshold. In certain examples, the WTRU 102 may track a differential between reported values (e.g., CQI and/or PH, among others) and may switch to a different reporting cycle, if a disparity between two measured values is larger than a certain threshold);
(12) accuracy, type, and/or granularity of the reported CSI,
   (for example, the WTRU 102 may switch to a certain configured CSI reporting pattern, may activate a given CSI reporting pattern and/or may deactivate a given CSI reporting pattern, if the measured quantity that can be reported has an accuracy above a certain threshold. Accuracy may be taken as a function of the granularity of the measurement or the number of reporting bits. Related measurements may be subject to a configured accuracy (e.g., accuracy requirement), which may be different from typical measurements of the same nature. For example, the WTRU 102 may activate a certain CSI reporting patterns, if a number of CSI bits exceeds a threshold (e.g., is lower than or greater than a certain threshold); and/or
(13) a function of receiving and/or satisfying an aperiodic CSI reporting trigger, as described herein,
   (for example, the WTRU 102 may switch to a certain configured CSI reporting pattern, may activate a given CSI reporting pattern and/or may deactivate a given CSI reporting pattern, after satisfying any or a subset of the CSI reporting triggers), among others.

The WTRU 102 may have a single active CSI reporting pattern at a given time. The WTRU 102 may deactivate an active CSI reporting pattern before or prior to activating another CSI reporting pattern. In some examples, some WTRUs 102 may be configured or predetermined, as a function of the WTRU capabilities, to have more than one active CSI reporting pattern. The WTRU 102 may use a union of active reporting occasions from active CSI reporting patterns. For overlapping occasions, the WTRU 102 may select one or more occasions associated with the highest priority, service, and/or LCH.

In certain examples, the WTRU 102 may be configured with multiple CSI reporting patterns such that on a CSI reporting pattern (e.g., each pattern) the WTRU 102 may report CSI of different granularity and/or different types. The WTRU 102 may activate or deactivate a secondary CSI reporting pattern, after satisfying the configured triggers. The WTRU 102 may provide more granular and/or better accuracy CSI reporting via the secondary CSI reporting pattern. In some examples, the WTRU 102 may report CSI in multiply stages (e.g., two or more stages). For example, the WTRU 102 may report CSI in a first stage by default (e.g., per a legacy behavior for periodic or semi-persistent CSI reporting), and the WTRU 102 may report CSI in a second stage (e.g., with more granularity and/or better accuracy) after the WTRU 102 satisfies the applicable aforementioned triggers for the second stage CSI reporting.

In certain embodiments, multiple CSI reporting patterns may be configured within a single CSI reporting configuration, and the WTRU 102 may report a subset of the configured reporting occasions (e.g., by switching between or among reporting patterns within the same configuration), as a function of the aforementioned triggers.

### Representative Procedures for Selective Reporting, for Example, to Reduce UCI Overhead

The network (e.g., a network entity) may overprovision the density of CSI reporting occasions for a certain CSI reporting configuration, for example to meet or exceed a link adaptation latency (e.g., required link adaptation latency) for a given service, such as an URLLC service, and/or an eMBB service, among others. The WTRU 102 may report CSI on a subset of configured reporting occasions. For example, the WTRU 102 may report CSI, after a selective subset of CSI-RS occasions, on a subset of configured reporting occasion. The WTRU 102 may determine, on its own from signaling and/or a configuration by the network (e.g., via a network entity), the TSN traffic pattern properties, including a periodicity and packet arrival offset from a slot boundary. For example, the WTRU 102 may determine the TSC traffic periodicity from core network signaling, an RRC configuration and/or from an activation of an associated DL SPS resource.

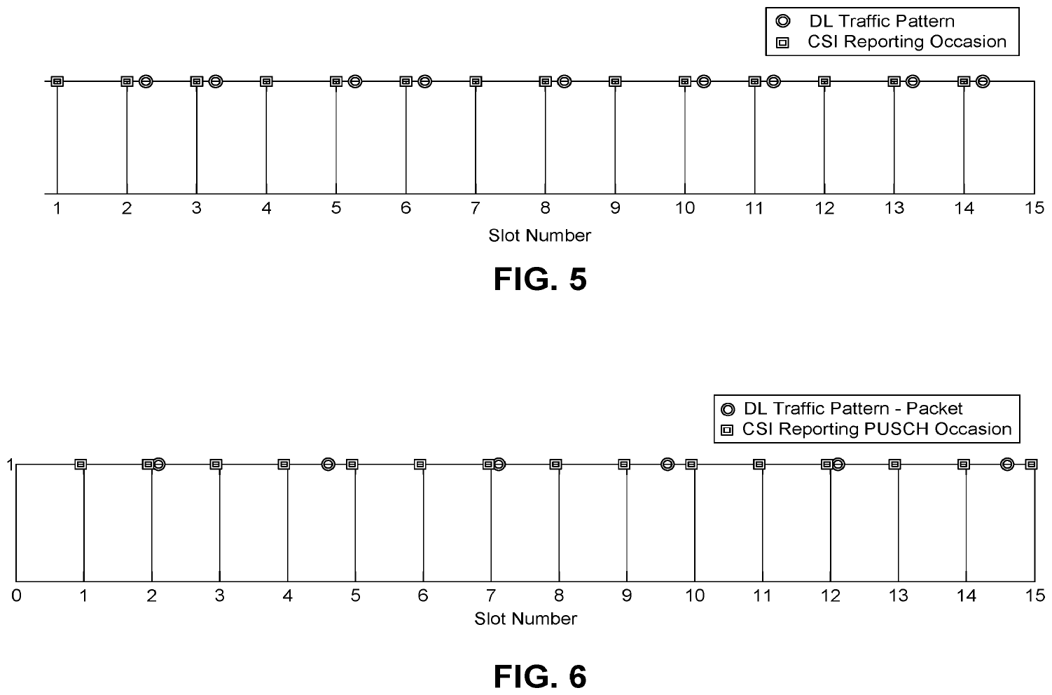

FIG. 5 is a diagram illustrating an example of WTRU selective CSI reporting with x=1 and y=3, where x≥0 and y≥1 (e.g., only report on y−x of every y occasions). A DL traffic pattern may occur in which a packet can arrive at every 2 of 3 slots with an offset. A front-loaded PUCCH resource may be used for the CSI reporting occasion with a periodicity of 1 slot.

Referring to FIG. 5, the WTRU 102 may skip reporting CSI for x occasions every configured y occasions. The WTRU 102 may be configured by RRC signaling with values for x and y. The WTRU 102 may be configured with a starting reporting offset relative to a frame boundary. The y reported occasions may or may not be consecutive. The reporting occasions may depend on a configured pattern in accordance with RRC signaling (e.g., by RRC).

FIG. 6 is a diagram illustrating another example of WTRU selective CSI reporting.

Referring to FIG. 6, the DL traffic pattern may include a DL packet arriving every 2.5 slots. The PUCCH periodicity=1 slot (e.g., with a back-loaded PUCCH resource). The back-loaded PUCCH resource may be used for the CSI reporting occasion with a periodicity of 1 slot.

In the traffic pattern illustrated in FIG. 6, since a DL packet can arrive every 2.5 slots, skipping reporting x every y occasions may not work well for such a scenario as the DL traffic periodicity is not divisible by the PUCCH periodicity. For example, if the WTRU 102 skips every other PUCCH CSI reporting occasion (e.g., if the WTRU 102 reports CSI on even slots (for example only on even slots)), the result may be, in a worst case, a CSI reporting delay of 1.75 slots for the DL packet arriving in the 9^{th} slot. An improved selective CSI reporting procedure may include the WTRU 102 skipping xCSI reporting occasions after receiving (e.g., after successfully receiving) a DL assignment (e.g., on the PDSCH) or control signaling (e.g., on the PDCCH) for an associated DL traffic pattern and/or priority. The WTRU 102 may start or restart a timer (e.g., a reporting prohibit timer) after receiving a DL assignment (e.g., on the PDSCH) and/or control signaling (e.g., on the PDCCH) for an associated DL traffic pattern. The WTRU 102 may skip CSI reporting while the timer is running. The value of x or the timer (e.g., the timer expiry) may be configured by higher layers (e.g., via RRC signaling or other higher layer signaling) for the CSI reporting configuration. The value of x or the timer (e.g., the timer expiry) may be determined by the WTRU 102 from the periodicity of the associated DL traffic pattern (e.g., as a scaled value or a multiple of the periodicity of the associated DL traffic pattern).

The WTRU 102 may report CSI on reporting occasions (e.g., only on reporting occasions) within a period of time before the next expected DL assignment and/or control signaling for a determined DL traffic pattern. The period may be configured by higher layers (e.g., via RRC signaling or other higher layer signaling) and/or may be determined from the periodicity of the associated DL traffic pattern (e.g., a scaled value).

The WTRU 102 may skip x CSI reporting occasions after reporting CSI for a given reporting configuration and/or after reporting CSI on y consecutive occasions. The WTRU 102 may start or restart a timer (e.g., a reporting prohibit timer) after reporting CSI for a given reporting configuration and/or after reporting CSI on y consecutive occasions. The WTRU 102 may skip CSI reporting while the timer is running. The value of x, y, and/or the timer (e.g., the timer expiry) may be configured by higher layers (e.g., via RRC signaling or other higher layer signaling) for the CSI reporting configuration. The value of x, y, and/or the timer (e.g., the timer expiry) may be determined by the WTRU 102 from the periodicity of the associated DL traffic pattern (e.g., as a scaled value or a multiple of the periodicity).

The WTRU 102 may suspend CSI reporting after reporting CSI for a given reporting configuration until the WTRU 102 receives a DL assignment (e.g., on the PDSCH) and/or control signaling (e.g., on the PDCCH), a DL assignment (e.g., on the PDSCH) and/or control signaling (e.g., the PDCCH) for an associated DL traffic pattern and/or priority, and/or until any of the CSI reporting triggers described herein is satisfied.

The WTRU 102 may apply a time domain offset to a subset of reporting occasions, as a function of the associated DL traffic pattern. For example, the WTRU 102 may shift the next CSI reporting occasion by a configured shift (e.g., 1 slot, ½ slots, n slots, and/or 1/n slots, among others, where n is a positive integer) if the time between the configured reporting occasion and the next DL packet arrival is larger than a configured threshold. In other examples, the WTRU 102 may apply a configured time-domain offset every x^{th} occasion, where x is configured by higher layers (e.g., via RRC signaling or other higher layer signaling).

### Representative Procedure for Enhanced CSI Accuracy

The WTRU 102 may apply any of the following, for example to provide CSI suited to a specific resource allocation. The examples may be useful for a scheduler to obtain more accurate CSI when the resource allocation for the WTRU 102 is not expected to change over a period (e.g., a relatively long period, for example longer than a threshold, such as when DL SPS is used).

### Representative Procedure for Customized CSI Measurement and Reporting

In some examples, the WTRU 102 may derive and/or may report CSI for at least one specific resource indicated to the WTRU 102 by physical layer, MAC layer and/or RRC signaling. CSI reporting may sometimes be referred to as Customized CSI reporting, and the at least one specific resource may be referred to as an “indicated resource”. For example, the indicated resource may correspond to a DL assignment dynamically, semi-persistently or semi-statically indicated. For example, the indicated resource may be a DL SPS assignment, that may be for a specific SPS configuration index. In other examples, parameters for the indicated resource may be configured by RRC and/or indicated in DCI, such as, for example a DCI that may trigger an aperiodic CSI report.

For example, the DCI may contain an index to a set of parameters configured by higher layers (such as the RRC layer or MAC layer), or an index to an SPS configuration.

### Representative Modified CSI Reference Resource

In certain examples, the CSI reference resource for which the WTRU 102 derives CSI for a customized CSI report may be set and/or defined based on the indicated resource. For example, in the frequency domain, the CSI reference resource may correspond to the frequency allocation of the indicated resource. In the time domain, the CSI reference resource for a CSI report in an UL slot may be a function of at least the time allocation of the indicated resource. For example, the CSI reference resource in the time domain may correspond (e.g., directly correspond) to the time allocation or, for a semi-persistent (SPS) assignment, to the time allocation of a specific repetition. The repetition may correspond to a latest repetition earlier than a timing of the CSI report minus a threshold, or to an earliest repetition later than the timing of the CSI report plus a threshold. The value of the threshold may depend on a configuration of CSI measurement resources.

### Representative Customized Sub-Bands

In certain examples, the WTRU 102 may report CSI for a sub-band set defined based on the indicated resource. For example, the sub-band may correspond to (e.g., directly correspond to) a frequency allocation of the indicated resource. In other examples, the sub-band may be selected, based on a CSI report configuration and/or a BWP configuration, from a set of candidate sub-bands (e.g., possible sub-bands set, determined and/or defined according to a legacy implementation). The selected sub-band may be one for which an overlap between the frequency allocation of the indicated resource and the sub-band is maximum. The CSI reference resource may be set, determined, and/or defined in the same way as in the legacy implementation in at least the frequency domain.

### Representative Procedure for a Report Conditioned on an Indicated Resource

The WTRU 102 may report any subset of legacy CSI parameters (LI, CQI, PMI, RI, and/or CRI). In some embodiments, any of the CSI parameters may be conditioned to a transmission parameter indicated by the physical layer, the MAC layer and/or RRC signaling, and may be part of, or provided along with the indicated resource. The transmission parameter may include any or all of the parameters provided in a DCI containing a DL assignment and/or a SPS activation, such as a MCS for each TB, a MCS table (either indicated by a RNTI or a search space), one or more antenna ports, a transmission configuration indication, and the like.

For example, in certain embodiments, the WTRU 102 may report an indication of a difference between a smallest MCS and/or code rate that can or would result in not exceeding a specific TB error probability and an MCS or code rate indicated and/or determined by a SPS activation or other assignment/indication. The TB error probability may be explicitly configured or dependent on another configuration aspect/parameter such as a configured CQI table. The difference may be reported in terms of a number of indices in a table such as an MCS table and/or a CQI table. The WTRU 102 may report an indication (e.g., a 1-bit indication, 2-bit indication or a multi-bit indication) of whether the indicated MCS may or would result in a TB error probability meeting or exceeding a target (e.g., above, equal to or above, below, or equal to or below) the target. In some examples, the WTRU 102 may report an indication if (e.g., only if) the difference may or would be different than zero (0) and/or if the indication may or would be multiplexed with another UCI or data transmission.

### Representative Report of Best Resource Among Set of Indicated Resources

In certain embodiments, physical layer, MAC layer or RRC signaling may indicate more than one resource and/or set of parameters. For example, the WTRU 102 may be configured and/or active with more than one SPS assignment. The WTRU 102 may report an index to the SPS configuration that can maximizes channel quality, CQI and/or other CSI parameters. In other examples, the WTRU 102 may be configured (e.g., via the RRC layer) with a set of candidate MCS and/or code rate values and may report an index to a value of the smallest MCS and/or code rate among the candidates for which a target TB error rate is not exceeded. In certain representative embodiments, a WTRU 102 configured with at least one SPS assignment may report an index to the SPS configuration that has the smallest rank, MCS, code rate and/or spectral efficiency among SPS configurations, for example, for which a target TB error rate is not exceeded. In certain examples, a WTRU 102 may report a largest or a smallest index among SPS configurations for which a target TB error rate is not exceeded, for example on condition that the network (e.g., a network entity) configures the at least one SPS by order of spectral efficiency.

Representative Report of CSI on Codeblock (CB) and/or Codeblock Group (CBG) Basis

In certain embodiments, the WTRU 102 may report CSI for at least one CB and/or CBG, for example associated to an indicated resource. For example, the WTRU 102 may report a highest CQI index for a CB or a CBG such that for a PDSCH encoded with corresponding parameters (e.g., a MCS, and/or a code rate, among others), the CB or CBG may be received with an error probability not exceeding a target. The CQI may be referred to as CB-CQI. The WTRU 102 may make an independent determination for a potential CB or a CBG (e.g., each potential CB or CBG), for example on condition that a PDSCH transmission is over the indicated resource. The WTRU 102 may report any or all CBG-CQIs and may use differential encoding, for example to minimize overhead. For example, the WTRU 102 may report the index of one of: a worst CBG-CQI or a best CBG-CQI. The WTRU 102 may report other CBG-CQIs as a difference between the CBG-CQI index of a CB, a CBG, or a CBG-CQI index (e.g., each CB, each CBG or each CBG-CQI index of one of: a worst CBG-CQI or a best CBG-CQI).

### Representative Measurement Resource for Customized CSI, for Example Including Modulated Symbols

In certain embodiments, the WTRU 102 may be configured to perform measurement and/or decoding over a resource, for example to report customized CSI. The resource may sometime be referred to as a customized measurement resource. A customized measurement resource may include or consist of any of: (1) one or more Reference Signals (RSs) that may occupy or overlap an indicated resource, (for example an RS may have a structure similar to DM-RS and/or CSI-RS); (2) a PDSCH transmission assigned dynamically, semi-persistently (SPS) or semi-statically, (for example the customized CSI reporting may also sometimes be referred to as enhanced HARQ-ACK reporting); and/or (3) one or more sets of modulated symbols, (for example, each set may be generated according to the same procedure as PDSCH and may be mapped over a portion of the measurement resource), among others.

In certain representative embodiments, a set (e.g., each set) may be generated from the encoding of a sequence of information bits. The sequence may be a known sequence such as a pseudo-random sequence initialized by a parameter pre-defined or signaled to the UE. The parameter may be set-specific.

In certain representative embodiments, a set (e.g., each set) may be encoded and rate-matched separately using a set-specific MCS and/or coding rate. The MCS and/or coding rates for the set (e.g., each set) may be signaled to the WTRU 102 as part of the configuration of the measurement resource. The MCS and/or the coding rate of a first set may be determined from the MCS and/or the coding rate of a first set according to a rule. For example, the MCS may be increasing with a step size with (e.g., in accordance with) an increasing set index within the customized measurement resource.

In certain representative embodiments, a set (e.g., each set) may consist of or include one or more CBs, one or more CBGs or one or more TBs.

In certain representative embodiments, the number of sets and/or the step size may be configured by higher layers or signaled by the MAC layer and/or the physical layer.

In certain representative embodiments, on condition that the customized measurement resource includes a PDSCH and/or modulated symbols, the WTRU 102 may attempt to decode the information bits and/or may determine whether the set (e.g., each set) is decoded successfully, for example by checking at least one Cyclic Redundancy Check (CRC) appended to the information bits for the set (e.g., each set). The CRC may include a CB-level CRC or a TB-level CRC in case a set consists of or includes at least one CB or TB). The WTRU 102 may report the following information in a customized CSI report: (1) one or more indications of the decoding status of at least one set or each set, such as (i) an indication of success or failure for the set (e.g., each set (e.g., in a bitmap), and/or (ii) an indication of a lowest set index or a highest set index for which decoding was unsuccessful, and/or of the highest set index or lowest set index for which decoding was successful; and/or (2) an indication of signal quality for at least one set or each set, such as a signal-to-interference ratio (SIR) or log-likelihood ratio (LLR).

Representative Procedure for Activation and/or Deactivation of Customized CSI Measurement and Reporting

In certain embodiments, resources for measurement of customized CSI and/or transmission (e.g., on or using the PUCCH and/or the PUSCH) of a customized CSI report may be activated and/or released. The WTRU 102 may perform measurement for (e.g., only for) an activated measurement resource. The WTRU 102 may perform transmission of a customized CSI for (e.g., only for) an activated transmission resource. One or more resources may be activated based on any of: (1) reception of an activation command by physical layer, MAC layer and/or RRC signaling, and/or (2) activation of an associated indicated resource, such as SPS activation for an associated SPS configuration, among others. One or more resources may be released based on any of: (1) reception of a release command by physical layer, MAC layer and/or RRC signaling, and/or (2) release of an associated indicated resource, such as SPS release for an associated SPS configuration, among others.

For example, the resource for the customized CSI transmission may be defined relative to the indicated resource. As another example, a resource for the CSI transmission may be in a slot that is N slots before an SPS instance. The value of the offset N may be configured and/or indicated: (1) as part of the activation command and/or the release command; and/or (2) by activation and/or release of the corresponding SPS configuration.

Resource Sharing with HARQ-ACK

The resource for the transmission of a customized CSI report may be the same resource as the resource for transmission of HARQ-ACK for the PDSCH used as measurement resource for the customized CSI report. The WTRU 102 may determine whether to transmit a customized CSI report based on RRC layer signaling, MAC layer signaling and/or physical layer signaling. For example, the WTRU 102 may determine whether a customized CSI report may be or is to be transmitted based on any of: (1) an indication from the DCI scheduling, activating and/or reactivating the PDSCH used as the measurement resource and/or triggering the measurement resource; (2) a priority indication for HARQ-ACK or other UCI; (3) a MCS table used for transmitting the PDSCH; and/or (4) an aspect of the CSI configuration such as the BLER target, among others.

### Representative Procedure for Triggering for a High Priority HARQ-ACK by a NACK

The WTRU 102 may trigger transmission of a CSI report, possibly including a legacy CSI report and/or a customized CSI report as described herein, for example if any of the following conditions are met: (1) the HARQ-ACK is a NACK; (2) the HARQ-ACK is for a PDSCH transmission corresponding to a specific SPS configuration; (3) the HARQ-ACK belongs to a HARQ-ACK codebook of a certain priority (e.g., above a threshold); and/or (4) the PDSCH was scheduled using a certain MCS table or a certain MCS or MCS range, among others.

### Representative Procedure for Partial Channel State Report

The WTRU 102 may be configured to report part (e.g., only part) of the CSI. For example, the WTRU 102 may be scheduled with a TB having a MCS value of x and having a BLER target of y. Upon decoding the TB and measuring the experienced SINR (e.g., using the Demodulation Reference Signal (DMRS) of the PDSCH and/or from other L1 measurements), the WTRU 102 may report the offset (e.g., only the offset) between the assumed/expected SINR from the network (e.g., a network entity and/or a gNB 180) (e.g., the minimum SINR, for example the minimum required SINR to decode the scheduled TB with a BLER target equal to y) and the experience/actual SINR. The set of candidate/possible offsets may be configured by the network (e.g., a network entity and/or a gNB 180) and may be a function of the MCS value x. As an example, for each MCS value, a set of candidate/possible offsets may be configured. The partial channel state report may be reported along with the HARQ-ACK as described herein, for example via resource sharing with the HARQ-ACK. The triggers to report the partial channel state report can be the same as any of the triggers described herein.

### Representative Procedure for Enhanced Channel State Information (CSI) Measurement and Reporting

A WTRU 102 may be configured with enhanced CSI measurement and reporting. Enhanced CSI measurements and reporting may include any of: (1) Reference Signal (RS) resources (e.g., enhanced CSI measurement and reporting may be associated to a set of RSs and/or enhanced CSI measurements may be performed on multiple elements of the set of RSs); (2) measurement types (e.g., enhanced CSI measurements may be used to report different types of CQI, and/or measurements in addition to RI/PM I/CQI/CRI or the like); (3) reporting triggers; (4) reporting resources; and/or (5) activation/deactivation and/or toggle triggers (for example this may include triggers to activate and/or deactivate enhanced CSI measurements and/or enhanced CSI reporting.

Enhanced CSI measurement and reporting may be configured by higher layer signaling. Enhanced CSI measurement and reporting may be configured, activated, deactivated, toggled and/or triggered as a function of a requirement of an associated transmission. For example, a WTRU 102 may perform enhanced CSI measurement and reporting when the WTRU 102 has high priority data to receive and/or to transmit. Enhanced CSI measurement and reporting may be triggered by any of:
(1) DCI (for example, a DCI may indicate to the WTRU 102 to begin and/or to end enhanced CSI measurements and reporting. The indication may be explicit (e.g., the indication may be performed via an information element of the DCI). In another example, the indication may be implicit (e.g., the WTRU 102 may determine to begin enhanced CSI measurement and reporting, if the DCI indicates a specific transmission type, and/or if the DCI points to a specific resource type. In another example, any of: (1) a DCI type, (2) a DCI format, (3) a search space where the DCI is detected, (4) a RNTI and/or (5) any other parameter of the DCI may be used to indicate to the WTRU 102 to begin and/or end the enhanced CSI measurement and reporting);
(2) a MAC CE (for example, the WTRU 102 may receive indication to begin and/or end the enhanced CSI measurement and reporting by an information element in a MAC CE);
(3) higher layer signaling (for example RRC configuration or reconfiguration may trigger the WTRU 102 to begin and/or end enhanced CSI measurement and reporting.
(4) demodulation performance (for example, the WTRU 102 may begin and/or end enhanced CSI measurements and reporting as a function of a BLER calculated on received transmissions); and/or
(5) measurement values (for example, the WTRU 102 may begin and/or end enhanced CSI measurements and reporting based on e.g., another measurement value. In an example, the WTRU 102 may determine that the CQI is of a value above or below a threshold that may trigger the WTRU 102 to begin, end or toggle enhanced CSI measurements and reporting), among others.
   Representative Procedure for CSI Measurement Derived from Measurements Over Multiple Resources

A WTRU 102 may perform a CSI measurement over multiple RSs or over multiple transmissions of an RS. In certain examples, a WTRU 102 may segment different REs of an RS and may perform measurements on each segment. For example, the segmentation may be per resource block (RB) and/or per subband, such that a single RS spanning multiple subbands/RBs may be treated as multiple separate resources on which to perform measurements.

A WTRU 102 may obtain statistical CSI measurements over multiple RSs (e.g., in frequency and/or in time) and/or over multiple segments of an RS (e.g., segmented in frequency and/or in time). The WTRU 102 may obtain statistical measurements over the multiple RSs and/or multiple RS segments. Such statistical measurements may include any of: (1) the mean, (2) the median, (3) the variance, (4) the set of best measurements; and/or (5) the set of worst measurements, and the like. For example, a WTRU 102 may perform measurements on an RS that spans multiple subbands and/or multiple slots. The WTRU 102 may measure (1) interference, (2) channel, (3) SINR, and/or (4) CQI or the like per segment. For example, the WTRU 102 may obtain, for example, any of:
(1) for mean statistical measurements: (i) a mean interference measurement value, (ii) a mean channel measurement value, (iii) a mean SINR, and/or (iv) a mean CQI;
(2) for median statistical measurements: (i) a median interference measurement value, (ii) a median channel measurement value, (iii) a median SINR and/or (iv) a median CQI;
(3) for variance statistical measurements: (i) a variance interference measurement value, (ii) a variance channel measurement value, (iii) a variance SINR and/or (iv) a variance CQI;
(4) for greatest measurements: (i) a greatest interference measurement value, (ii) a greatest channel measurement value, (iii) a greatest SINR and/or (iv) a greatest CQI;
(5) for smallest measurements: (i) a smallest interference measurement value, (ii) a smallest channel measurement value, (iii) a smallest SINR and/or (iv) a smallest CQI;
(6) for a set of best/worst measurements: (i) a set of best subbands and/or slots in terms of interference measurement value, channel measurement value, SINR and/or CQI, and/or (ii) a set of worst subbands and/or slots in terms of interference measurement value, channel measurement value, SINR and/or CQI;
(7) for Probability Distribution Function (PDF) or Cumulative Distribution Function (CDF): (i) interference measurement value distributions, (ii) channel measurement value distributions, (iii) SINR distributions and/or (iv) CQI distributions (for example such distributions may be reported as histograms.

### Representative Procedure for Measurements Over Multiple Slots

In another example, the WTRU 102 may obtain the aforementioned measurements on RSs spanning multiple slots (e.g., timing periods). For example, the WTRU 102 may determine the number of slots and/or the set of slots on which to perform measurements as a function of the timing of the report (e.g., CSI report). In certain examples, the WTRU 102 may determine the number of slots and/or the set of slots on which to perform measurements as a function of the timing of a measurement calculation.

A WTRU 102 may use a sliding window on/from which statistical measurements may be obtained. A size of the window may be determined in terms of absolute time. The size (e.g., the length in time) of the window may be predetermined, configurable, determined by the WTRU 102 and/or indicated by signaling from the gNB 180 to the UE. In certain representative embodiment, the size of the window may be determined in terms of the number of RS samples.

A WTRU 102 may be configured with one or more window sizes. The WTRU 102 may maintain measurements for more than one window size, for example to enable the WTRU 102 to report measurements that provide information on short and/or long-term trends.

### Representative Procedures for Measurement Types

The WTRU 102 may obtain measurement types as a function of the statistical measurements obtained over a segmented RS or multiple RSs. For example, the WTRU 102 may obtain multiple different CSI (e.g., CQI and/or SINR) types as a function of the types of channel and interference measurements used to calculate the CSI. A WTRU 102 may calculate a one-shot and/or instantaneous CSI value as determined by one-shot and/or instantaneous measurements. In certain representative embodiments, the WTRU 102 may calculate a statistical CSI as a function of a combination of one-shot measurements (e.g., for channel measurements or for less dynamically changing measurement) and statistical measurements (e.g., for interference or more dynamically changing measurements).

A WTRU 102 may calculate predictive CSIs in terms of a trend observed over a set of measurement resources. The predictive CSI may indicate whether a value is increasing or decreasing (and/or the acceleration/deceleration).

### Representative Procedures for Interference Measurement Resource Configuration

A WTRU 102 may be configured with multiple types of interference measurement resources. For example, a WTRU 102 may measure interference on a CSI-Interference Measurement (CSI-IM), a Zero Power (ZP) CSI-RS and/or a Non-Zero Power (NZP) CSI-RS. The WTRU 102 may be configured with sets of interference measurement resources on which the WTRU 102 may perform statistical CSI measurements. The sets may or may not be limited to a single type of interference measurement resource. In certain examples, the WTRU 102 may have multiple interference measurement resources in a set and/or the interference measurement resources in the set may have different RS types. The interference resource type may dictate the type of interference measurement the WTRU 102 may perform. For example, a WTRU 102 may use a NZP CSI-RS interference resource, for example to determine worst case interference.

### Representative Procedures for CSI Report Determination

Depending on the measurements performed, a WTRU 102 may obtain different CSI measurement types. For example, a WTRU 102 may obtain different values of CQI. A first type of CSI measurement may provide instantaneous CQI over a measurement resources, a second type of CSI measurement may provide statistical CQI over a first set of measurement resources, a third type of CSI measurement may provide statistical CQI over a second set of measurement resources. Each CQI may be obtained from a different combination of channel measurement (e.g., instantaneous or statistical) and/or interference measurement (e.g., instantaneous or statistical).

A WTRU 102 may be configured with a set of CSI (e.g., CQI) types to report. In certain examples, a WTRU 102 may determine the appropriate CSI (e.g., CQI) type to report. The WTRU 102 may include a CQI type identifier to indicate the CQI type being reported. The selection of the CSI type may be determined as a function of one or more measurements. For example, the WTRU 102 may be configured with rules such as if a first measurement type is above or below threshold, the WTRU 102 reports a second measurement type.

To determine CSI reports (such as RI and/or PMI and the like), the WTRU 102 may use bias values, for example in the calculation of the channel and/or interference measurements. The WTRU 102 may be configured with, may obtain via signaling, and/or may determine one or more (e.g., or a set of) the bias values. Each bias value may be associated to the type of channel and/or interference measurement used to determine the CSI reports (e.g., other CSI reports). A WTRU 102 may report multiple RI/PM I values, for example one associated with each CQI type reported.

Representative Procedures for CSI Measurement Determined from Demodulation Performance

A WTRU 102 may obtain CSI measurements as a function of the demodulation performance of a DL transmission. Based on the demodulation, the WTRU 102 may determine any of: (1) how far from a successful decoding a failed decoding is (e.g., a degree/measurement of failure); (2) how far from a failed decoding a successful decoding is (e.g., a degree/measurement of success); (3) How many resources (e.g. RBs) were unnecessary due to a transmission being overly conservative (e.g., a degree/measurement of overscheduling); (4) How many more resources (e.g. RBs) would be required to make a transmission successfully decoded (e.g., a degree/measurement of under-scheduling).

The WTRU 102 may determine the above (e.g., the demodulation performance) in terms of SINR and/or CQI value. The WTRU 102 may determine a difference in SINR and/or CQI value between achieving the requirements of the transmission (e.g., achieving the required BLER target or block error probability (e.g., which may be different per priority level, per application and/or per service) and what was actually received at the WTRU 102 for the transmission. For example, the WTRU 102 may report the SINR experienced for the transmission and/or the WTRU 102 may report the difference between the SINR detected and that required to achieve the appropriate BLER target and/or whether the difference is above or below a threshold. In certain examples, the WTRU 102 may report the desired MCS (and/or CQI) for a transmission to achieve the BLER target, and/or the WTRU 102 may report the difference between the MCS level used and that required to achieve the BLER target. In certain examples, the WTRU 102 may report an estimate of a block error probability or a function thereof (such as logarithm). In certain examples, the WTRU 102 may report if the difference between the estimated block error probability and a target block error probability is above or below a threshold. An indication of whether a difference between a SINR or block error probability and a target (or an absolute value thereof) is above or below a threshold may be referred to as an indication of high or low margin, respectively.

The WTRU 102 may determine the difference between a code rate used and mutual information of the channel and may report the difference value (e.g., report back) to the gNB.

The WTRU 102 may report the demodulation-based CSI per codeblock, per codeblock group, per transport block, per set of transport blocks, per carrier, per HARQ/ACK report, per set of HARQ processes and/or per slot. For example, the WTRU 102 may report a demodulation-based CSI value for: (1) one or multiple HARQ-ACK reports, (2) one or multiple ACK reports; and/or (3) one or multiple NACK reports, among others. In certain representative embodiments, the WTRU 102 may report a demodulation-based CSI value per each NACK report and/or a demodulation-based CSI value per set of multiple ACK reports. For example, the WTRU 102 may report a demodulation-based CSI value for a set of ACKed TBs (and/or Code Block Groups (CBGs)). For example, such a report may provide the average obtained over the set of multiple ACKed TBs (and/or CBGs), for example to enable the gNB 180 to adjust its code rate to make better use of available resources. As another example, the WTRU 102 may report a demodulation-based CSI value per each NACK, for example because it may be useful, required, and/or critical to ensure the TB (or CBG) is retransmitted effectively.

The WTRU 102 may report statistical values associated with demodulation-based CSI reporting. For example, for multiple transmissions, the WTRU 102 may determine the mean/median/variance/best/worst values of CQI levels offset from the BLER (e.g., required BLER). The WTRU 102 may group multiple transmissions such that the transmissions share a parameter. The parameter used to determine the group of multiple transmissions for which statistical demodulation-based CSI measurements may be performed may include any of: (1) priority of the associated PDSCH, (2) whether the HARQ-ACK of the associated PDSCH is ACK or NACK, and/or (3) the carrier/beam/subband on which the PDSCH is transmitted. The WTRU 102 may report a function of a set of demodulation-based CSI values. For example, the WTRU 102 may report an indication of whether at least one, or none of the demodulation-based CSI values indicates a low margin.

The WTRU 102 may determine to report demodulation-based CSI, on condition that (e.g., if) the value (e.g., CSI value) is offset greater than or less than a value (e.g., configurable value, predetermined value and/or signaled value). The WTRU 102 may indicate in a feedback report whether the demodulation-based CSI is included or is not included, for example in (e.g., the CSI report, with a HARQ-ACK, or in another feedback mechanism transmission).

The WTRU 102 may determine whether to report a demodulation-based CSI measurement as a function of the associated PDSCH, the associated PDSCH group and/or HARQ processes) and/or a parameter thereof. The parameter which may determine whether a WTRU 102 reports a demodulation based CSI may include any of: (1) a priority of the transmission, (2) whether the HARQ-ACK is an ACK or a NACK, (3) a HARQ process ID, (4) a Redundancy Version (RV) of the transmission, (5) an MCS used, (6) a Transport Block Size (TBS) used,(7) a number of symbols used for the PDSCH, (8) a beam (and/or Quasi Co-Location (QCL) assumption), and/or (9) a PDSCH group ID, among others.

For UL transmission, the WTRU 102 may indicate (e.g., in a request) to the gNB 180 the desired MCS or TBS such that segmentation may be reduced/limited, for example to reduce over-all latency. A WTRU 102 may report the request in a PUSCH transmission (e.g., indicating a desired change for a subsequent UL transmission) and/or the WTRU 102 may report the request via an SR resource selection.

### Representative Procedures for CSI Report Transmission

A WTRU 102 may report (e.g., report back) any of the enhanced CSI measurements in dedicated report resources. For example, the WTRU 102 may be configured with PUCCH resources on which to report statistical CSI. In certain examples, the WTRU 102 may multiplex enhanced CSI measurement types with other CSI reports. For example, a WTRU 102 may be configured with resources on which to report Rank Indicator (RI)/Precoding Matrix Indicator (PMI)/CQI along with statistical CQI. As another example the statistical CQI may be reported with any of: (1) RI, (2) PMI, and/or (3) CQI (e.g., non-statistical CQI).

In certain representative embodiments, the WTRU 102 may feedback enhanced CSI measurements along with HARQ-ACK reports. For example, the WTRU 102 may include demodulation-based CSI along with HARQ-ACK reports. The mapping of feedback bits may be such that for each TB (and/or CBG) the feedback includes a first set of bits indicating ACK or NACK and a second set of bits indicating the demodulation-based CSI report. A HARQ-ACK report may have a set of bits reserved for the reporting of enhanced CSI measurements, including demodulation-based CSI. The reserved bits may be determined as a value that is dependent of the size of the HARQ-ACK codebook. The reserved bits may be fixed and independent of the size of the HARQ-ACK codebook.

### Representative Procedures for Priority of CSI Report

In certain cases, the enhanced CSI measurement report may be multiplexed with other feedback (e.g., CSI and/or HARQ-ACK, among others) reports. If the payload of a report resource is limited, the WTRU 102 may have to prioritize the report type to provide to the gNB. The priority of an enhanced CSI measurement report may be determined by any of:
(1) a higher layer configuration/signaling;
(2) based on a measurement value to be reported (for example, a demodulation-based CSI measurement for a NACKed TB and/or CBG may have higher priority than that of an ACKed TB and/or CBG. In another example, the WTRU 102 may determine a priority of a CQI type based on whether the measurement value is greater than or less than a threshold value (e.g., for that CQI type). The threshold value may be fixed or may be dependent on a previously transmitted feedback value);
(3) based on an associated transmission (for example, a demodulation-based CSI measurement obtained from a high priority transmission may have high priority. In another example, a statistical CSI measurement triggered for a high priority transmission, may have high priority);
(4) dynamically indicated by the gNB 180 (for example, the priority of an enhanced CSI measurement report may be determined by a DCI triggering the report; and/or
(5) the CSI report type/priority and/or HARQ-ACK priority with which the enhanced CSI measurement report is colliding. For example, an enhanced CSI measurement report may have higher priority than other CSI report types, but a lower priority than HARQ-ACK. In another example, the CSI measurement report type may be an intermediate priority and higher than one type of CSI report and/or HARQ-ACK report (e.g., the intermediate priority may be higher in priority than a lower priority of the one type of CSI report and/or HARQ-ACK reports) but may be a lower in priority than other types of CSI reports and/or HARQ-ACK reports (e.g. the intermediate priority may be lower in priority than a higher priority of the other types of CSI reports and/or HARQ-ACKs).

When a priority of a report is determined based on the measurement value, there may be ambiguity at the network whether an enhanced CSI measurement report is included and/or is to be included. The feedback resource selection may be determined as a function of whether an enhanced CSI measurement report is multiplexed or not. In another example, the WTRU 102 may include an indicator in a feedback report indicating whether enhanced CSI measurement reports are included.

### Representative Procedures for CSI Report Transmission

The enhanced CSI measurement reports may be included in any of:
(1) one or more PUCCH resources, for example PUCCH resources for periodic CSI reports and/or PUCCH resources for HARQ-ACK feedback;
(2) a PUSCH resource (e.g., dynamically granted and/or configured resource);
(3) a MAC CE (for example, statistical CSI reports may be included in MAC CE that may not be time critical. In another example, the WTRU 102 may transmit statistical demodulation-based CSI on ACKed transmissions. Given that the transmissions are successful, reporting of the statistical demodulation-based CSI may not be time critical, as feedback. The WTRU 102 may use resources that enable greater payload, but may not be as readily available); and/or
(4) SR resource, among others.

A WTRU 102 may determine whether to transmit an enhanced CSI measurement report and/or the timing of the enhanced CSI measurement report based on any of:
(1) periodic feedback resources (e.g., availability and/or number of period feedback resources);
(2) determined by the DCI (e.g., as indicated by the DCI) (for example, a DCI may indicate the timing of a report for an aperiodic enhanced CSI report feedback and/or for a demodulation-based CSI feedback (e.g., mapping to the HARQ-ACK feedback resources). As an example of aperiodic enhanced CSI report feedback, the WTRU 102 may be triggered by the gNB 180 to report statistical and/or demodulation-based CSI measurements. The WTRU 102 may collect demodulation-based CSI and may report an average and/or a set of values when triggered by the gNB);
(3) based on measurement values (for example, a WTRU 102 may report enhanced CSI, if the measurement value or a set of measurement values is/are above or below a threshold. The threshold may be fixed or may be determined based on a previously transmitted measurement report. In other examples, a WTRU 102 may determine to feedback a demodulation-based CSI report based on the current BLER of one or more TBs and/or CBGs);
(4) reported based on satisfying a condition (for example, the WTRU 102 may report a statistical CSI value if the WTRU 102 has obtained a measurement value that is within a reliability range. In other examples, hysteresis may be used to determine whether to report an enhanced CSI measurement value; and/or
(5) a parameter of an associated transmission (for example, the WTRU 102 may determine whether to report demodulation-based CSI measurements as a function of one or more parameters of an associated PDSCH. The one or more parameters of the associated PDSCH may include any of: (i) a priority, (ii) an MCS, (iii) a TBS, (iv) a duration, (v) a number of repetition, (vi) a repetition number, and/or (vii) the number of slots, among others.

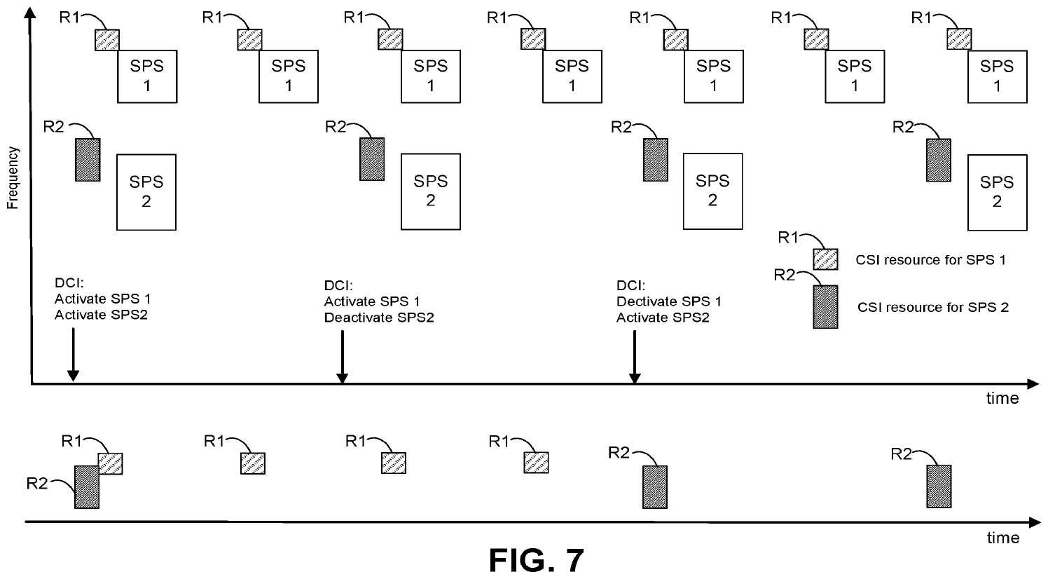

FIG. 7 is a diagram illustrating enhanced CSI reporting using multiple CSI RS resource configurations. Referring to FIG. 7, a WTRU 102 may receive a plurality of CSI measurement or reporting configurations (for example establishing first and second sets of CSI measurement resources R1 and R2 respectively) and multiple downlink (DL) semi-persistent scheduling (SPS) resource configurations (for example establishing first DL SPS resource configuration 1 and second DL SPS resource configuration 2). The periodicity of CSI measurement resources R1 of the first DL SPS resource configuration 1 may be different from (e.g., twice the periodicity or some other periodicity) of that of the CSI measurement resources R2 for the second DL SPS resource configuration 2). The WTRU 102 may receive an indicator (for example in the DCI or other control signaling) indicating which one or more of the multiple DL SPS resource configurations SPS 1 and/or SPS 2 are active.

For example, the DCI for a first interval/slot may indicate that SPS resource configuration 1 and SPS resource configuration 2 are active and the WTRU 102 may use/select for use the CSI measurement resources R1 and R2. The CSI measurement resources R1 sand R2 may be used for CSI measurements until deactivated via another indication in the DCI. At a subsequent interval/slot, the DCI for a subsequent interval/slot may indicate that SPS resource configuration 1 is active and SPS resource configuration 2 is inactive (e.g., deactivated). At a later interval/slot, the DCI for the later interval/slot may indicate that SPS resource configuration 1 is inactive (e.g., deactivated) and SPS resource configuration 2 is active (e.g., activated). In certain representative embodiments, the indication in the DCI may be a one-bit information element (IE) per configuration and may indicate a change (from a former state e.g., from active to inactive or from inactive to active) or may indicate the actual state (e.g., active or inactive). The resulting CSI measurement resources used in such a case are illustrated in FIG. 7. For example, CSI measurement resources R1 and R2 may be used in the first interval/slot. CSI measurement resource R1 may be used in the second, third and fourth intervals/slots. CSI measurement resource R2 may be used in the fifth and seventh intervals/slots. As additional CSI measurement resources or reduced CSI measurement resources are needed/use, the amount and timing of the CSI measurement resources may be varied by activating or deactivating one or more SPS resource configurations SPS1 or SPS2 (e.g., by varying any number of such configurations).

The indication may be periodic, aperiodic, or triggered via control signaling. When DL SPS resource configuration SPS 1 is activated, the CSI measurement resources associated with the DL SPS configuration SPS 1 are used, for example to enable CSI reporting for measurements performed on these associated CSI measurement resources via associated CSI reporting resources. When DL SPS resource configuration SPS 1 is not activated, the CSI measurement resources associated with DL SPS resource configuration SPS 1 are not used, for example disabling CSI reporting for measurements performed on the associated CSI measurement resources. When DL SPS resource configuration SPS 2 is activated, the CSI measurement resources associated with DL SPS resource configuration SPS 2 are used, for example to enable CSI reporting for measurements performed on these associated CSI measurement resources via associated CSI reporting resources. When DL SPS resource configuration SPS 2 is not activated, the CSI measurement resources associated with DL SPS resource configuration SPS 2 are not used, for example disabling CSI reporting for measurements performed on these associated CSI measurement resources.

In certain representative embodiments, the WTRU 102 may determine one or more measurement time/frequency resources based on a respective CSI measurement or reporting configuration or respective CSI measurement or reporting configurations associated with the one or more activated DL SPS resource configurations. The WTRU 102 may perform one or more measurements on the determined measurement resources and may report CSI based on the one or more measurements.

In certain representative embodiments, on condition that more than one of the DL SPS resource configurations are activated, the WTRU 102 may indicate, for example to a network entity and/or the gNB, the activated DL SPS resource configuration with a largest MCS for which a target BLER is not exceeded and/or achieved.

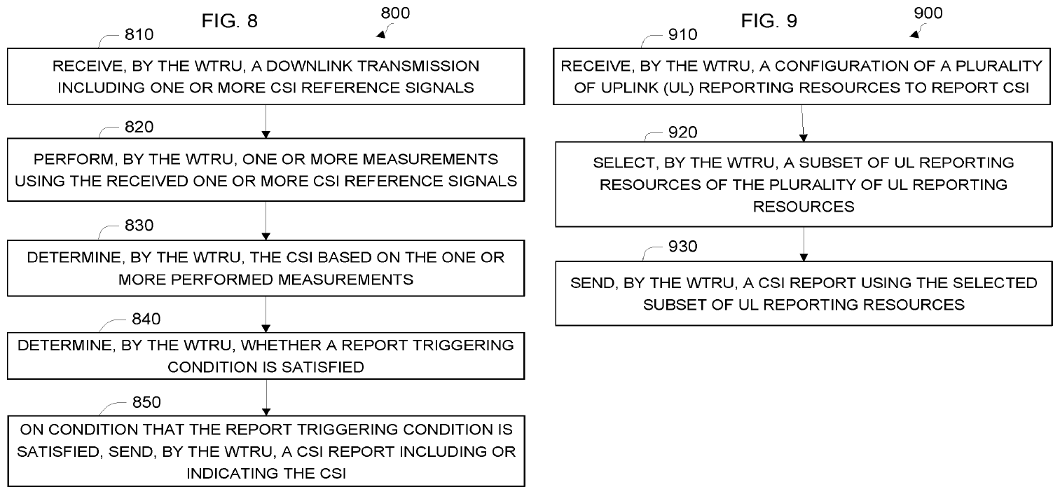

FIG. 8 is a flowchart illustrating a representative method of reporting Channel State Information (CSI) by a WTRU.

Referring to FIG. 8, the representative method 800 may include the WTRU 102 receiving, at block 810, a downlink transmission including one or more CSI reference signals. At block 820, the WTRU 102 may perform one or more measurements using the received one or more CSI reference signals. At block 830, the WTRU 102 may determine the CSI based on the one or more performed measurements. At block 840, the WTRU 102 may determine whether a report triggering condition is satisfied. At block 850, on condition that the report triggering condition is satisfied, the WTRU 102 may send a CSI report including or indicating the CSI.

For example, the determination of whether the report triggering condition is satisfied may include any of: (1) the WTRU 102 receiving from a network entity 160 or 180, an explicit indication that the report triggering condition is satisfied; and/or (2) the WTRU 102 determining whether the report triggering condition is satisfied based on any of: (i) receiving downlink (DL) control information for DL or uplink (UL) scheduling, (ii) activating semi-persistent scheduling, (iii) receiving a priority DL transmission; (iv) transmitting a priority UL transmission, (v) receiving a Medium Access Control (MAC) Control Element (MAC CE), (vi) transmitting or triggering a scheduling Request (SR) and/or a Buffer Status Report, (vii) data arrival for certain services, certain data radio bearers (DRBs), certain logical channel groups (LCGs), certain logical channels (LCHs), and/or certain priority levels, (viii) changes in CSI measurements or measured channel conditions, (ix) a HARQ-ACK report and/or HARQ-ACK codebook values, (x) decoding performance, (xi) whether a scheduled transmission is a new transmission or retransmission, and/or (xii) a number of retransmissions of a transport block.

In certain representative embodiments, the determination of whether the report triggering condition is satisfied may include: determining whether an exception condition is satisfied and on condition that an exception condition is satisfied, the report triggering condition is not satisfied.

In certain representative embodiments, the WTRU 102 may activate an uplink UL control channel resource to send the CSI report. The CSI report may be an aperiodic CSI report or a periodic CSI report.

In certain representative embodiments, the WTRU 102 may prior to the determination of whether the report triggering condition is satisfied, activate the reporting condition.

In certain representative embodiments, the determination of whether the report triggering condition is satisfied may include a determination of whether the report triggering condition is activated.

FIG. 9 is a flowchart illustrating another representative method of reporting Channel State Information (CSI).

Referring to FIG. 9, the representative method 900 may include, at block 910, the WTRU 102 receiving a configuration of a plurality of uplink (UL) reporting resources to report CSI. At block 920, the WTRU 102 may select a subset of UL reporting resources of the plurality of UL reporting resources. At block 930, the WTRU 102 may send a CSI report using the selected subset of UL reporting resources. For example, the WTRU 102 may send the CSI report along with uplink data.

In certain representative embodiments, the WTRU 102 may perform one or more measurements to determine the CSI using one or more CSI reference signals. For example, the WTRU 102 may determine the CSI based on the one or more performed measurements and/or may determine an amount of UL data that can be transmitted on the selected subset of UL reporting resources. In certain representative embodiments the WTRU 102 may generate a CSI report for the selected subset of UL reporting resources in accordance with the determined CSI and/or the determined amount of UL data.

In certain representative embodiments the WTRU 102 may perform one or more measurements to determine the CSI using one or more CSI reference signals, may determine the CSI based on the one or more performed measurements and may generate a CSI report in accordance with the determined CSI.

In certain representative embodiments the selection of the subset of UL reporting resources may include selecting the subset of UL reporting resources based on any of: (1) measured channel conditions; (2) a channel quality indicator (CQI) and a transport block size (TBS); and/or (3) whether segmentation is applied for a buffered Medium Access Control Service Data Unit (MAC SDU) for accompanied data.

In certain representative embodiments, the receiving of the configuration may include receiving a configuration of a plurality of reporting patterns. For example, the selecting of the subset of UL reporting resources may (e.g., may then) include: selecting a configured reporting pattern; and selecting the subset of UL reporting resources from the reporting resources associated with the selected reporting pattern.

In certain representative embodiments, the selection of the subset of UL reporting resources may include: the WTRU 102 determining whether a triggering condition is satisfied and on condition that the triggering condition is satisfied, the WTRU 102 switching from the selected reporting pattern to another configured reporting pattern, as a newly selected reporting pattern. For example, the subset of UL reporting resources may be selected from the reporting resources associated with the newly selected reporting pattern.

In certain representative embodiments, the triggering condition may include any of: (1) the WTRU 102 receiving a dynamic indication, (2) the WTRU 102 receiving a dynamic scheduling with a priority associated with a different reporting pattern, (3) expiry of an inactivity timer associated with an active CSI pattern, and/or (4) the WTRU 102 transitioning into a DRX state associated with a different reporting pattern.

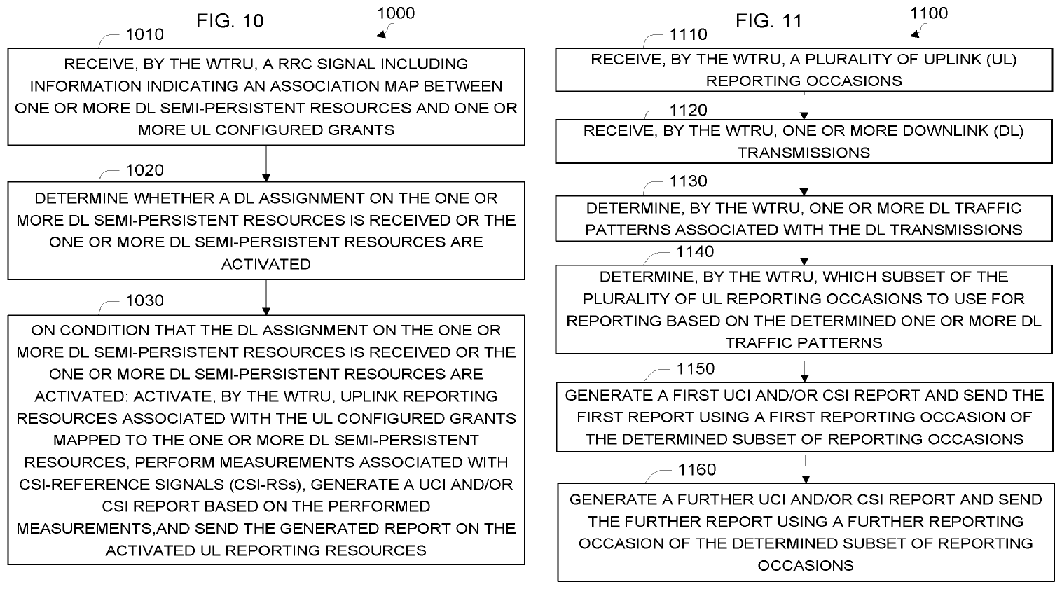

FIG. 10 is a flowchart illustrating a representative method of UCI and/or CSI reporting.

Referring to FIG. 10, the representative method 1000 may include, at block 1010, the WTRU 102 receiving a signal (e.g., RRC signal) including information indicating an association map between one or more DL semi-persistent resources and one or more UL configured grants. At block 1020, the WTRU 102 may determine whether a DL assignment on the one or more DL semi-persistent resources is received or the one or more DL semi-persistent resources are activated. At block 1030, the WTRU 102 may, on condition that the DL assignment on the one or more DL semi-persistent resources is received or the one or more DL semi-persistent resources are activated: activate uplink reporting resources associated with the UL configured grants mapped to the one or more DL semi-persistent resources, perform measurements associated with CSI-Reference Signals (CSI-RS), generate a UCI and/or CSI report based on the performed measurements, and/or send the generated report on the activated UL reporting resources. For example, after the DL assignment on the one or more DL semi-persistent resources is complete, the WTRU may deactivate the activated UL reporting resources.

FIG. 11 is a flowchart illustrating another representative method of UCI and/or CSI reporting.

Referring to FIG. 11, the representative method 1100 may include, at block 1110, the WTRU 102 receiving, by the WTRU, a plurality of uplink (UL) reporting occasions.

At block 1120, the WTRU 102 may receive one or more downlink (DL) transmissions. At block 1130, the WTRU 102 may determine one or more DL traffic patterns associated with the DL transmissions. At block 1140, the WTRU 102 may determine which subset of the plurality of UL reporting occasions to use for reporting based on the determined one or more DL traffic patterns. At block 1150, the WTRU 102 may generate a first UCI and/or CSI report and may send the first report using a first reporting occasion of the determined subset of reporting occasions. At block 1160, the WTRU 102 may generate a further UCI and/or CSI report and may send the further report using a further reporting occasion of the determined subset of reporting occasions.

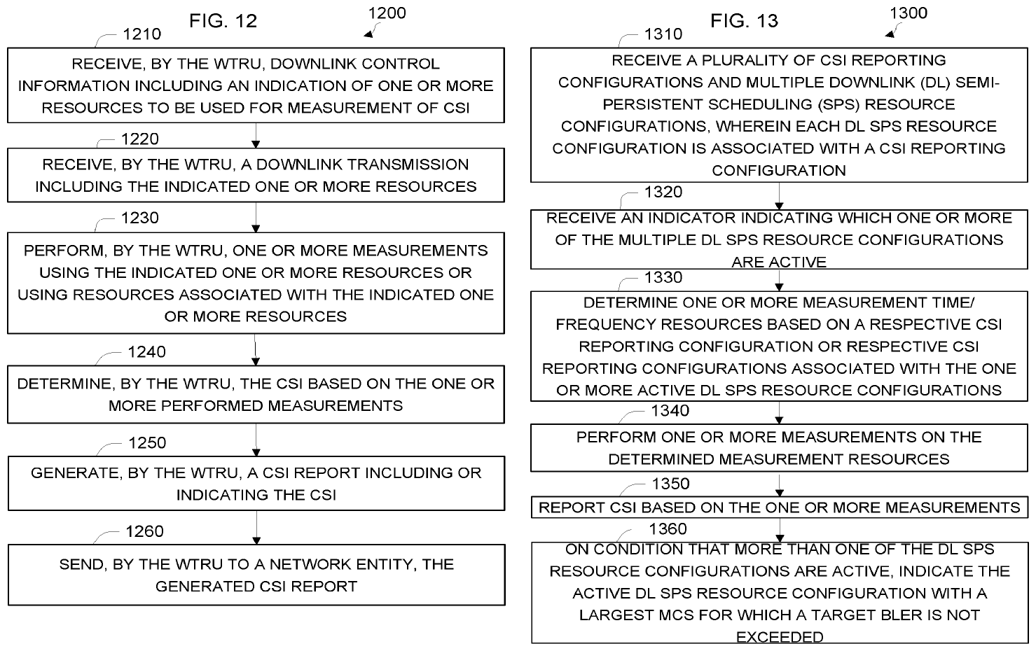

FIG. 12 is a flowchart illustrating a further representative method of reporting CSI.

Referring to FIG. 12, the representative method 1200 may include, at block 1210, the WTRU 102 receiving downlink control information including an indication of one or more resources to be used for measurement of CSI. At block 1220, the WTRU 102 may receive a downlink transmission including the indicated one or more resources. At block 1230, the WTRU 102 may perform one or more measurements using the indicated one or more resources or using resources associated with the indicated one or more resources. At block 1240, the WTRU 102 may determine the CSI based on the one or more performed measurements. At block 1250, the WTRU 102 may generate a CSI report including or indicating the CSI. At block 1260, the WTRU 102 may send, to a network entity, the generated CSI report.

FIG. 13 is a flowchart illustrating a still further representative method of reporting Channel State Information (CSI).

Referring to FIG. 13, the representative method 1300 may include, at block 1310, the WTRU 102 receiving a plurality of CSI reporting configurations and multiple downlink (DL) semi-persistent scheduling (SPS) resource configurations. For example, each DL SPS resource configuration may be associated with a CSI reporting configuration. At block 1320, the WTRU 102 may receive an indicator indicating which one or more of the multiple DL SPS resource configurations are active. At block 1330, the WTRU 102 may determine one or more measurement time/frequency resources based on a respective CSI reporting configuration or respective CSI reporting configurations associated with the one or more active DL SPS resource configurations. At block 1340, the WTRU 102 may perform one or more measurements on the determined measurement resources.

At block 1350, the WTRU 102 may report CSI based on the one or more measurements. At block 1360, the WTRU 102, on condition that more than one of the DL SPS resource configurations are active, may indicate the active DL SPS resource configuration with a largest MCS for which a target BLER is not exceeded.

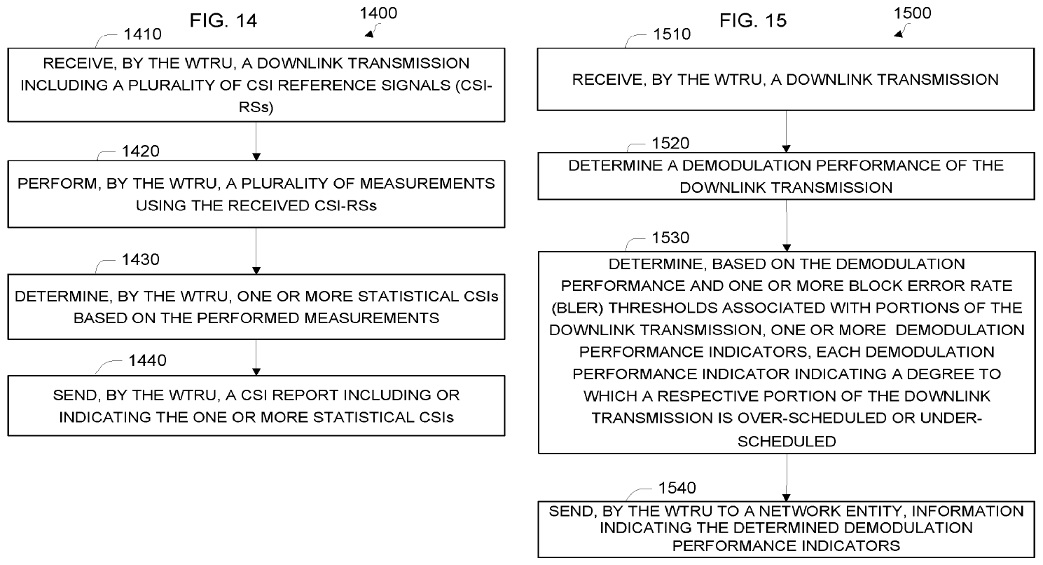

FIG. 14 is a flowchart illustrating an additional representative method of reporting Channel State Information (CSI).

Referring to FIG. 14, the representative method 1400 may include, at block 1410, the WTRU 102 receiving a downlink transmission including a plurality of CSI reference signals (CSI-RSs). At block 1420, the WTRU 102 may perform a plurality of measurements using the received CSI-RSs. At block 1430, the WTRU 102 may determine one or more statistical CSIs based on the performed measurements. At block 1440, the WTRU 102 may send a CSI report including or indicating the one or more statistical CSIs. For example, a statistical CSI may be associated with: (1) a set of reference signals (RSs) on a single transmission; (2) a single RS on multiple transmissions, or (3) a set of reference signals (RSs) on multiple transmissions.

In certain representative embodiments, the WTRU 102 may receive a CSI reporting configuration including a plurality of CSI reporting types, and, for example, at least one of the CSI reporting types is a statistical CSI reporting type.

In certain representative embodiments, the WTRU 102 may trigger a statistical CSI reporting type in accordance with any of: (1) higher layer signaling, (2) a received Downlink Control Information (DCI) indication, (3) a received indication in a Medium Access Control Element (MAC CE), (4) demodulation performance based on a Block Error Rate (BLER) associated with one or more received transmissions; and/or (5) one or more CSI-related measurement values.

In certain representative embodiments, the WTRU 102 may determine CSI-RSs in a window defined by any of: a time or number of samples in a time domain or a number of subcarriers or sub-bands in a frequency domain from which to perform the measurement. For example, the statistical CSIs may include any of: (1) a mean value of the performed measurement associated with the CSI-RSs in the window; (2) a median value of the performed measurement associated with the CSI-RSs in the window; (3) a largest value of the performed measurement associated with the CSI-RSs in the window; (4) a smallest value of the performed measurement associated with the CSI-RSs in the window; (5) a variance of the performed measurement associated with the CSI-RSs in the window; and/or (6) a distribution function related to the performed measurement associated with the CSI-RSs in the window.

In certain representative embodiments, the CSI report may be sent using any of: (1) one or more PUCCH resources, (2) a PUSCH grant; (3) a Medium Access Control Element (MAC CE), and/or (4) SR resources.

In certain representative embodiments, the statistical CSIs may be based on measurements performed on a set of RSs. For example, the statistical CSIs may include any of: (1) a mean value of the performed measurement associated with the set of RSs; (2) a median value of the performed measurement associated with the RSs; (3) a largest value of the performed measurement associated with the RSs; (4) a smallest value of the performed measurement associated with the RSs; (5) a variance of the performed measurement associated with the RSs; and/or (6) a distribution function related to the performed measurement associated with the RSs. The RSs may include CSI-RSs, DM-RS, Interference Management (IM)-RSs and/or other RSs of a different type.

FIG. 15 is a flowchart illustrating a representative method of reporting.

Referring to FIG. 15, the representative method 1500 may include, at block 1510, the WTRU 102 receiving a downlink transmission. At block 1520, the WTRU 102 may determine a demodulation performance of the downlink transmission. At block 1530, the WTRU 102 may determine, based on the demodulation performance and one or more Block Error Rate (BLER) thresholds associated with portions of the downlink transmission, one or more demodulation performance indicators. For example, each demodulation performance indicator may indicate a degree to which a respective portion of the downlink transmission is over-scheduled or under-scheduled. At block 1540, the WTRU 102 may send, to a network entity, information indicating the determined demodulation performance indicators. For example, the determination of the demodulation performance indicators includes estimating a difference in Channel Quality Indicator (CQI) or Signal to Interference and Noise Ratio (SINR) associated with satisfying a BLER threshold of the respective portion of the downlink transmission and/or a measured SINR of the respective portion of the downlink transmission. In some examples, the sent information may include the estimated difference in CQI or SINR.

In certain representative embodiments, the WTRU 102 may determine the demodulation performance of the downlink transmission based on any of: Channel State Information Reference Signals (CSI-RSs); a channel estimation using Demodulation Reference Signals (DM-RSs) or a Cyclic Redundancy Check (CRC).

In certain representative embodiments, the respective portion of the downlink transmission may correspond to any of: (1) one or more codeblocks, (2) one or more codeblock groups, (3) one or a set of transport blocks, (4) one or more carriers, (5) a HARQ/ACK report, (6) a set of HARQ processes; and/or (7) one or more slots.

In certain representative embodiments, information indicating the determined demodulation performance indicators may be sent: (1) along with a CSI report or along with a HARQ-ACK report.

In certain representative embodiments, the information indicating the determined degree to which one or more of the portions are over-scheduled or under-scheduled is sent: (1) along with a CSI report or with along with a HARQ-ACK report.

In certain representative embodiments, the determining of the demodulation performance indicators indicating that the respective portion of the downlink transmission is over-scheduled or under-scheduled may include estimating a difference in Channel Quality Indicator (CQI) or Signal to Interference and Noise Ratio (SINR) associated with satisfying a BLER threshold of the respective portion of the downlink transmission and a CQI or SINR of the respective portion of the downlink transmission. For example, the sent information may then include the estimated difference in CQI or SINR.

In certain representative embodiments, the WTRU 102 may determine to send the information indicating the determined demodulation performance indicators based on any of: (1) periodic feedback timing, (2) DCI triggering, (3) one or more measurement value, (4) a parameter of the DL transmission (e.g., a priority).

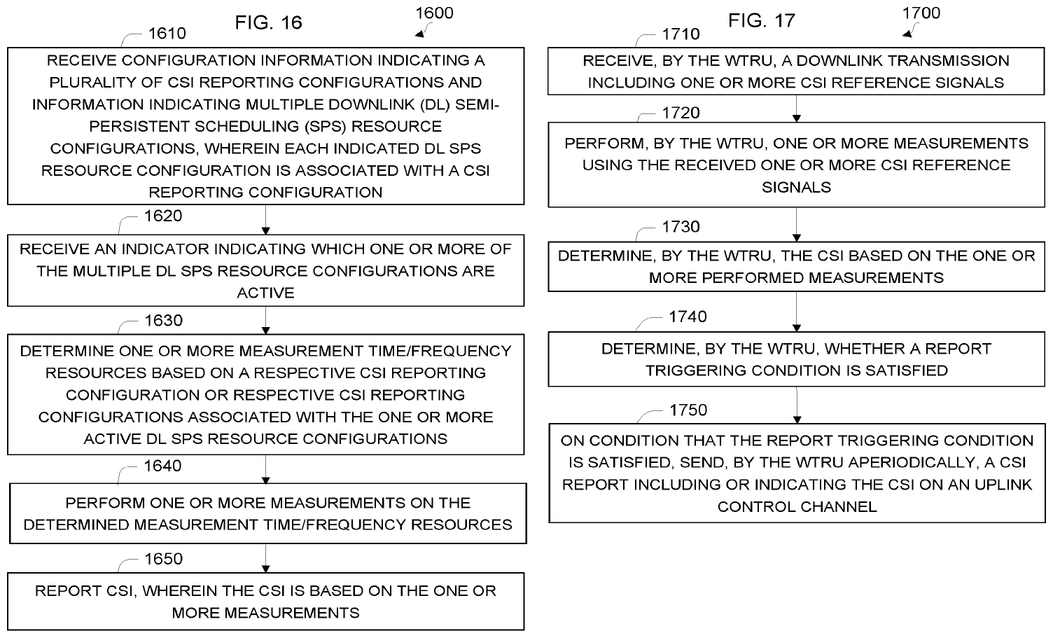

FIG. 16 is a flowchart illustrating a yet further representative method of reporting CSI by WTRU.

Referring to FIG. 16, the representative method 1600 may include, at block 1610, the WTRU 102 receiving configuration information indicating a plurality of CSI reporting configurations and information indicating multiple downlink (DL) semi-persistent scheduling (SPS) resource configurations. For example, each indicated DL SPS resource configuration may be associated with a CSI reporting configuration. At block 1620, the WTRU 102 may receive an indicator indicating which one or more of the multiple DL SPS resource configurations are active. At block 1630, the WTRU 102 may determine one or more measurement time/frequency resources based on a respective CSI reporting configuration or respective CSI reporting configurations associated with the one or more active DL SPS resource configurations. At block 1640, the WTRU 102 may perform one or more measurements on the determined measurement time/frequency resources. At block 1650, the WTRU 102 may report CSI. For example, the CSI may be based on the one or more measurements.

In certain representative embodiments, the CSI may be reported on a reporting resource associated with one of: (1) one or more CSI reporting configurations or (2) one or more DL semi-persistent scheduling (SPS) resource configurations.

In certain representative embodiments, on condition that more than one of the DL SPS resource configurations are active, the WTRU 102 may indicate the active DL SPS resource configuration with a largest modulation coding scheme (MCS) for which a target BLER is not exceeded.

In certain representative embodiments, the reporting of CSI may include sending an aperiodic CSI report on an uplink control channel.

In certain representative embodiments, the WTRU 102 may determine whether a report triggering condition is satisfied. For example, the reporting of the CSI may be based on the report triggering condition being satisfied.

In certain representative embodiments, the determining of whether the report triggering condition is satisfied may include any of: (1) receiving, by the WTRU from a network entity, an explicit indication that the report triggering condition is satisfied; or (2) determining whether the report triggering condition is satisfied based on any of: (i) receiving downlink (DL) control information for DL or uplink (UL) scheduling, (ii) activating semi-persistent scheduling, (iii) receiving a priority DL transmission; (iv) transmitting a priority UL transmission, (v) receiving a Medium Access Control (MAC) Control Element (MAC CE), (vi) transmitting or triggering a scheduling Request (SR) and/or a Buffer Status Report, (vii) data arrival for certain services, certain data radio bearers (DRBs), certain logical channel groups (LCGs), certain logical channels (LCHs), and/or certain priority levels, (viii) changes in CSI measurements or measured channel conditions, (ix) a HARQ-ACK report and/or HARQ-ACK codebook values, (x) decoding performance, (xi) whether a scheduled transmission is a new transmission or retransmission, and/or (xii) a number of retransmissions of a transport block.

In certain representative embodiments, the determining of whether the report triggering condition is satisfied may include determining whether an exception condition is satisfied. For example, on condition that an exception condition is satisfied, the report triggering condition may not be or is not satisfied.

In certain representative embodiments, the WTRU 102 may activate an uplink (UL) control channel resource to send the CSI report. For example, the CSI report may be an aperiodic CSI report.

In certain representative embodiments, prior to the determining of whether the report triggering condition is satisfied, the WTRU 102 may activate the report trigging condition.

In certain representative embodiments, the determining of whether the report triggering condition is satisfied may include determining whether the report triggering condition is activated.

In certain representative embodiments, the reporting of the CSI may include sending a CSI report along with uplink data.

In certain representative embodiments, the WTRU 102 may determine an amount of uplink data that is to be transmitted along with the CSI report on uplink resources associated with the one or more active DL SPS resource configurations. For example, the sending of the CSI report along with the uplink data may include sending the CSI report along with the determined amount of uplink data using the uplink resources associated with the one or more active SPS resource configurations.

In certain representative embodiments, the WTRU 102 may select reporting resources to report the CSI.

In certain representative embodiments, the selecting of the reporting resources to report the CSI may include selecting a subset of reporting resources associated with the active DL SPS resource configurations based on any of: (1) measured channel conditions; (2) a channel quality indicator (CQI) and a transport block size (TBS); or (3) whether segmentation is applied for a buffered Medium Access Control Service Data Unit (MAC SDU) for accompanied data.

In certain representative embodiments, the receiving of configuration information indicating the plurality of CSI reporting configurations may include receiving information indicating a plurality of reporting patterns.

In certain representative embodiments, the selecting of the subset of reporting resources may include: selecting one or more of the configured reporting patterns; and/or selecting reporting resources associated with the selected reporting pattern.

In certain representative embodiments, the selecting of the subset of reporting resources may include: the WTRU 102 determining whether a triggering condition is satisfied. For example, on condition that the triggering condition is satisfied, the WTRU 102 may switch from the selected reporting pattern to another configured reporting pattern, as a newly selected reporting pattern. In some embodiments, the WTRU 102 may select reporting resources from the reporting resources associated with the newly selected reporting pattern.

In certain representative embodiments, the selecting of the subset of reporting resources may include determining, by the WTRU 102, whether a triggering condition is satisfied. For example, on condition that the triggering condition is satisfied, the WTRU may any of: (1) add one or more non-selected and configured reporting patterns to the selected reporting patterns to enable newly selected reporting patterns, and/or (2) remove one or more of the selected and configured reporting patterns from remaining selected reporting patterns to enable the newly selected reporting patterns. In some embodiments, the WTRU 102 may select reporting resources from the reporting resources associated with the newly selected reporting patterns.

In certain representative embodiments, the triggering condition may include any of: (1) the WTRU 102 receiving a dynamic indication, (2) the WTRU 102 receiving a dynamic scheduling with a priority associated with a different reporting pattern, (3) expiry of an inactivity timer associated with an active CSI pattern, and/or (4) the WTRU 102 transitioning into a DRX state associated with a different reporting pattern.

In certain representative embodiments, the WTRU 102 may determine a demodulation performance of a downlink transmission; determine, based on the demodulation performance and one or more thresholds (e.g., Block Error Rate (BLER) thresholds) associated with portions of the downlink transmission, one or more demodulation performance indicators. For example, each demodulation performance indicator may indicate a degree to which a respective portion of the downlink transmission is over-scheduled or under-scheduled. In some embodiments, the WTRU 102 may send, to a network entity, information indicating the determined demodulation performance indicators.

In certain representative embodiments, the determining of the demodulation performance indicators indicating that the respective portion of the downlink transmission is over-scheduled or under-scheduled may include estimating a difference in Channel Quality Indicator (CQI) or Signal to Interference and Noise Ratio (SINR) associated with satisfying a BLER threshold of the respective portion of the downlink transmission and a measured SINR of the respective portion of the downlink transmission. In some embodiments, the sent information may include the estimated difference in CQI or SINR.

In certain representative embodiments, the respective portion of the downlink transmission may correspond to any of: (1) one or more codeblocks, (2) one or more codeblock groups, (3) one or a set of transport blocks, (4) one or more carriers, (5) a HARQ/ACK report, (6) a set of HARQ processes; and/or (7) one or more slots.

In certain representative embodiments, the information indicating the determined demodulation performance indicators may be sent along with a CSI report or with along with a HARQ-ACK report.

In certain representative embodiments, the information indicating the determined degree to which one or more of the portions are over-scheduled or under-scheduled may be sent along with a CSI report or along with a HARQ-ACK report.

FIG. 17 is a flowchart illustrating another representative method of reporting CSI by a WTRU.

Referring to FIG. 17, the representative method 1700 may include, at block 1710, the WTRU 102 receiving a downlink transmission including one or more CSI reference signals. At block 1720, the WTRU 102 may perform one or more measurements using the received one or more CSI reference signals. At block 1730, the WTRU 102 may determine the CSI based on the one or more performed measurements. At block 1740, the WTRU may determine whether a report triggering condition is satisfied. At block 1750, on condition that the report triggering condition is satisfied, the WTRU 102 may send (e.g., aperiodically send), a CSI report including or indicating the CSI on an uplink control channel.

In certain representative embodiments, the determining of whether the report triggering condition is satisfied may include any of: (1) receiving, by the WTRU 102 from a network entity (e.g., any network entity), an explicit indication that the report triggering condition is satisfied; and/or (2) determining whether the report triggering condition is satisfied based on any of: (i) receiving downlink (DL) control information for DL or uplink (UL) scheduling, (ii) activating semi-persistent scheduling, (iii) receiving a priority DL transmission; (iv) transmitting a priority UL transmission, (v) receiving a Medium Access Control (MAC) Control Element (MAC CE), (vi) transmitting or triggering a scheduling Request (SR) or a Buffer Status Report, (vii) data arrival for certain services, certain data radio bearers (DRBs), certain logical channel groups (LCGs), certain logical channels (LCHs), or certain priority levels, (viii) changes in CSI measurements or measured channel conditions, (ix) a HARQ-ACK report and/or HARQ-ACK codebook values, (x) decoding performance, (xi) whether a scheduled transmission is a new transmission or retransmission, or (xii) a number of retransmissions of a transport block.

In certain representative embodiments, the determining of whether the report triggering condition is satisfied may include: determining whether an exception condition is satisfied. For example, on condition that an exception condition is satisfied, the report triggering condition may not be or is not satisfied.

In certain representative embodiments, the WTRU 102 may activate an uplink control channel resource to send the CSI report. For example, the CSI report may be an aperiodic CSI report or another type of CSI report, such as a periodic CSI report.

In certain representative embodiments, prior to the determining of whether the report triggering condition is satisfied, the WTRU 102 may activate the report triggering condition.

In certain representative embodiments, the uplink control channel may be a Physical Uplink Control Channel (PUCCH).

In certain representative embodiments, the WTRU 102 may select a subset of reporting resources associated with the configured grant based on any of: (1) measured channel conditions; (2) a channel quality indicator (CQI) and a transport block size (TBS); and/or (3) whether segmentation is applied for a buffered Medium Access Control Service Data Unit (MAC SDU) for accompanied data. For example, the CSI report may include or indicate the CSI uses the selected subset of reporting resources on the uplink control channel.

In certain representative embodiments, the WTRU 102 may receive configuration information indicating a plurality of CSI reporting configurations, for example including a plurality of reporting patterns. In some embodiments, the selecting of the subset of reporting resources may include: selecting a configured reporting pattern; and selecting the subset of reporting resources from the reporting resources associated with the selected reporting pattern.

In certain representative embodiments, the selecting of the subset of reporting resources may include: the WTRU 102 determining whether a triggering condition is satisfied. For example, on condition that the triggering condition is satisfied, the WTRU 102 may switch from the selected reporting pattern to another configured reporting pattern, as a newly selected reporting pattern; and may select the subset of reporting resources from the reporting resources associated with the newly selected reporting pattern.

In certain representative embodiments, the triggering condition may include any of: (1) the WTRU 102 receiving a dynamic indication, (2) the WTRU 102 receiving a dynamic scheduling with a priority associated with a different reporting pattern, (3) expiry of an inactivity timer associated with an active CSI pattern, or (4) the WTRU 102 transitioning into a DRX state associated with a different reporting pattern.

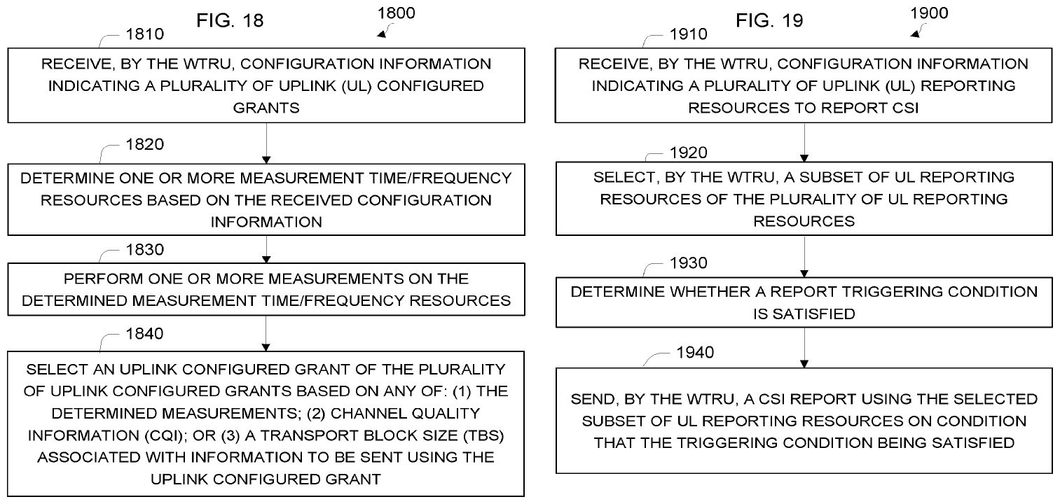

FIG. 18 is a flowchart illustrating a representative method using configured grants.

Referring to FIG. 18, the representative method 1800 may include, at block 1810, the WTRU 102 receiving configuration information indicating a plurality of uplink (UL) configured grants. At block 1820, the WTRU 102 may determine one or more measurement time/frequency resources based on the received configuration information. At block 1830, the WTRU 102 may perform one or more measurements on the determined measurement time/frequency resources. At block 1840, the WTRU 102 may select an uplink configured grant of the plurality of uplink configured grants based on any of: (1) the determined measurements; (2) channel quality information (CQI); or (3) a transport block size (TBS) associated with information to be sent using the uplink configured grant.

In certain representative embodiments, the receiving of the configuration information indicating the plurality of uplink configured grants may include receiving information indicating an association map between one or more downlink (DL) semi-persistent resources and the uplink configured grants. For example, the WTRU 102 may activate the UL reporting resources associated with the UL configured grants mapped to the one or more DL semi-persistent resources and/or may send a report on the activated UL reporting resources.

In certain representative embodiments, the WTRU 102 may after sending the report, deactivate the activated UL reporting resources.

FIG. 19 is a flowchart illustrating a further representative method of reporting CSI by a WTRU.

Referring to FIG. 19, the representative method 1900 may include, at block 1910, the WTRU 102 receiving configuration information indicating a plurality of uplink (UL) reporting resources to report CSI. At block 1920, the WTRU 102 may select a subset of UL reporting resources of the plurality of UL reporting resources. At block 1930, the WTRU 102 may determine whether a report triggering condition is satisfied. At block 1940, the WTRU 102 may sending a CSI report using the selected subset of UL reporting resources on condition that the triggering condition being satisfied.

In certain representative embodiments, the determining of whether the report triggering condition is satisfied may include any of: (1) receiving, by the WTRU 102 from a network entity (e.g., any network entity), an explicit indication that the report triggering condition is satisfied; and/or (2) determining whether the report triggering condition is satisfied based on any of: (i) receiving downlink (DL) control information for DL or uplink (UL) scheduling, (ii) activating semi-persistent scheduling, (iii) receiving a priority DL transmission; (iv) transmitting a priority UL transmission, (v) receiving a Medium Access Control (MAC) Control Element (MAC CE), (vi) transmitting or triggering a scheduling Request (SR) and/or a Buffer Status Report, (vii) data arrival for certain services, certain data radio bearers (DRBs), certain logical channel groups (LCGs), certain logical channels (LCHs), and/or certain priority levels, (viii) changes in CSI measurements or measured channel conditions, (ix) a HARQ-ACK report and/or HARQ-ACK codebook values, (x) decoding performance, (xi) whether a scheduled transmission is a new transmission or retransmission, and/or (xii) a number of retransmissions of a transport block.

In certain representative embodiments, the determining of whether the report triggering condition is satisfied may include: determining whether an exception condition is satisfied. For example, on condition that an exception condition is satisfied, the report triggering condition may not or is not satisfied.

In certain representative embodiments, the WTRU 102 may activate an uplink (UL) control channel resource to send the CSI report. For example, the CSI report may be an aperiodic CSI report or another type of report such as a periodic CSI report.

In certain representative embodiments, prior to the determining of whether the report triggering condition is satisfied, the WTRU 102 may activate the report triggering condition.

In certain representative embodiments, the determining of whether the report triggering condition is satisfied may include determining whether the report triggering condition is activated.

In certain representative embodiments, the sending of the CSI report may include sending the CSI report along with uplink data.

In certain representative embodiments, the WTRU 102 may perform one or more measurements to determine CSI using one or more CSI reference signals; may determine the CSI based on the one or more performed measurements; and/or may generate the CSI report in accordance with the determined CSI.

In certain representative embodiments, the selecting of the subset of UL reporting resources may include selecting the subset of UL reporting resources based on any of: (1) measured channel conditions; (2) a channel quality indicator (CQI) and a transport block size (TBS); and/or (3) whether segmentation is applied for a buffered Medium Access Control Service Data Unit (MAC SDU) for accompanied data.

In certain representative embodiments, the configuration information may include a plurality of reporting patterns. In some embodiments, the selecting of the subset of UL reporting resources may include: selecting a configured reporting pattern; and selecting the subset of UL reporting resources from the reporting resources associated with the selected reporting pattern.

In certain representative embodiments, on condition that the triggering condition is satisfied, the WTRU 102 may switch from the selected reporting pattern to another configured reporting pattern, as a newly selected reporting pattern. For example, the WTRU 102 may select the subset of UL reporting resources from the reporting resources associated with the newly selected reporting pattern.

In certain representative embodiments, the triggering condition may include any of: (1) the WTRU 102 receiving a dynamic indication, (2) the WTRU 102 receiving a dynamic scheduling with a priority associated with a different reporting pattern, (3) expiry of an inactivity timer associated with an active CSI pattern, and/or (4) the WTRU 102 transitioning into a DRX state associated with a different reporting pattern.

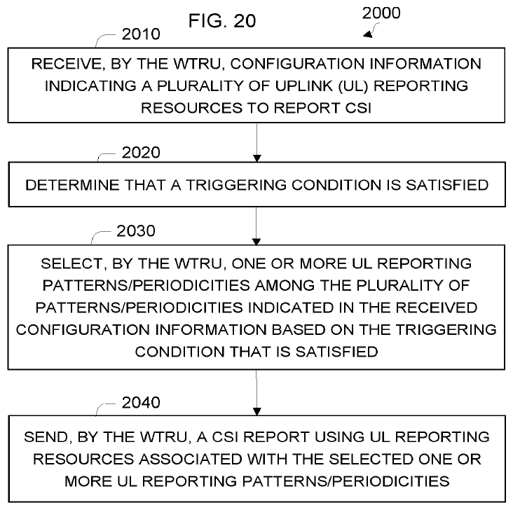

FIG. 20 is a flowchart illustrating a still further representative method of reporting CSI by a WTRU.

Referring to FIG. 20, the representative method 2000 may include, at block 2010, the WTRU 102 receiving configuration information indicating a plurality of uplink (UL) reporting patterns/periodicities to report CSI. At block 2020, the WTRU 102 may determine that a triggering condition is satisfied. At block 2030, the WTRU 102 may select one or more UL reporting patterns/periodicities among the plurality of patterns/periodicities indicated in the received configuration information based on the triggering condition that is satisfied. At block 2040, the WTRU 102 may send a CSI report using UL reporting resources associated with the selected one or more UL reporting patterns/periodicities.

In certain representative embodiments, the triggering condition may be determined to be satisfied based on any of: (1) an explicit indication from a network entity (e.g., any network entity) that the triggering condition is satisfied; (2) downlink (DL) control information for DL or uplink (UL) scheduling; (3) an activation of semi-persistent scheduling; (4) a reception of a priority DL transmission; (5) a transmission of a priority UL transmission; (6) a reception of a Medium Access Control (MAC) Control Element (MAC CE); (7) a transmission or a trigger of a Scheduling Request (SR) or a Buffer Status Report; (8) data arrival for certain services, certain data radio bearers (DRBs), certain logical channel groups (LCGs), certain logical channels (LCHs), or certain priority levels; (9) a change in CSI measurements or measured channel conditions; (10) a HARQ-ACK report and/or a HARQ-ACK codebook value; (11) a decoding performance; (12) whether a scheduled transmission is a new transmission or retransmission, or (13) a number of retransmissions of a transport block.

In certain representative embodiments, the WTRU 102 may perform one or more measurements to determine CSI using one or more CSI reference signals, may determine the CSI based on the one or more performed measurements; and/or may generate the CSI report in accordance with the determined CSI.

In certain representative embodiments, on condition that the triggering condition is satisfied, the WTRU 102 may switch from the selected reporting pattern/periodicity to another configured reporting pattern/periodicity, as a newly selected reporting pattern/periodicity. For example, the WTRU may select UL reporting resources associated with the newly selected reporting pattern/periodicity.

Systems and methods for processing data according to representative embodiments may be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within a robotic assistance/apparatus (RAA) and/or another mobile device remotely. In the later a case, data may be transferred via wireline or wirelessly between the RAA or other mobile device containing the sensors and the remote device containing the processor which runs the software which performs the scale estimation and compensation as described above. According to other representative embodiments, some of the processing described above with respect to localization may be performed in the device containing the sensors/cameras, while the remainder of the processing may be performed in a second device after receipt of the partially processed data from the device containing the sensors/cameras.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods. It should be understood that the representative embodiments are not limited to the above-mentioned platforms or CPUs and that other platforms and CPUs may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mate-able and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Throughout the disclosure, one of skill understands that certain representative embodiments may be used in the alternative or in combination with other representative embodiments.

In addition, the methods described herein may be implemented in a computer program, software, or firmware incorporated in a computer readable storage medium as instructions for execution by a computer or processor to perform the actions described hereinabove. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-28. (canceled)

29. A method implemented by a wireless transmit/receive unit (WTRU) for wireless communications, the method comprising:
receiving configuration information indicating 1) one or more configured grant (CG) resources for uplink data transmission, and 2) a mapping between a respective CG resource of the one or more CG resources and a respective signal;
selecting the respective CG resource from the one or more CG resources based on a measurement of the respective signal associated with the respective CG resource being above a measurement threshold; and
transmitting a message using the selected respective CG resource.

30. The method of claim 29, wherein the message comprises uplink data, and the message is transmitted based on the uplink data being associated with a data radio bearer (DRB) of a configured subset of DRBs for the respective CG resource.

31. The method of claim 29, wherein the message comprises uplink data, and the message is transmitted based on the uplink data being associated with a logical channel (LCH) of a configured subset of LCHs for the respective CG resource.

32. The method of claim 29, wherein the message comprises uplink data, and the message is transmitted based on the uplink data being associated with a logical channel group (LCG) of a configured subset of LCGs for the respective CG resource.

33. The method of claim 29, wherein the message comprises uplink data, and the message is transmitted based on the uplink data being new data for transmission.

34. The method of claim 29, wherein the respective signal comprises a respective set of synchronization signal blocks (SSBs), wherein the respective set of SSBs comprises one or more SSBs.

35. The method of claim 29, wherein the measurement threshold is a pre-configured measurement threshold of reference signal received power (RSRP).

36. The method of claim 29, wherein the measurement of the respective signal comprises a first value of reference signal received power (RSRP), and the measurement threshold comprises a second value of RSRP, and wherein the first value is larger than the second value.

37. The method of claim 29, wherein the respective signal comprises respective channel state information (CSI).

38. The method of claim 29, wherein the measurement of the respective signal comprises a channel state information (CSI) measurement or a synchronization signal block (SSB) measurement.

39. A wireless transmit/receive unit (WTRU) for wireless communications, the WTRU comprising:
a receiver configured to receive configuration information indicating 1) one or more configured grant (CG) resources for uplink data transmission, and 2) a mapping between a respective CG resource of the one or more CG resources and a respective signal;
a processor configured to select the respective CG resource from the one or more CG resources based on a measurement of the respective signal associated with the respective CG resource being above a measurement threshold; and
a transmitter configured to transmit a message using the selected respective CG resource.

40. The WTRU of claim 39, wherein the message comprises uplink data, and the message is transmitted based on the uplink data being associated with a data radio bearer (DRB) of a configured subset of DRBs for the respective CG resource.

41. The WTRU of claim 39, wherein the message comprises uplink data, and the message is transmitted based on the uplink data being associated with a logical channel (LCH) of a configured subset of LCHs for the respective CG resource.

42. The WTRU of claim 39, wherein the message comprises uplink data, and the message is transmitted based on the uplink data being associated with a logical channel group (LCG) of a configured subset of LCGs for the respective CG resource.

43. The WTRU of claim 39, wherein the message comprises uplink data, and the message is transmitted based on the uplink data being new data for transmission.

44. The WTRU of claim 39, wherein the respective signal comprises a respective set of synchronization signal blocks (SSBs), wherein the respective set of SSBs comprises one or more SSBs.

45. The WTRU of claim 39, wherein the measurement threshold is a pre-configured measurement threshold of reference signal received power (RSRP).

46. The WTRU of claim 39, wherein the measurement of the respective signal comprises a first value of reference signal received power (RSRP), and the measurement threshold comprises a second value of RSRP, and wherein the first value is larger than the second value.

47. The WTRU of claim 39, wherein the respective signal comprises respective channel state information (CSI).

48. The WTRU of claim 39, wherein the measurement of the respective signal comprises a channel state information (CSI) measurement or a synchronization signal block (SSB) measurement.
